(19) United States
(12) Patent Application Publication
(10) Pub. No.: US 2005/0038675 A1
(43) Pub. Date: Feb. 17, 2005

(54) Methods and systems for at-home and community-based care

(76) Inventors: Jeffrey A. Siekman, Loveland, OH (US); Shawn P. Reese, Miamisburg, OH (US)

Correspondence Address: John S. Beulick;Armstrong Teasdale LLP, Suite 2600, One Metropolitan Square, St. Louis, MO, 63102, US

(21) Appl. No.: 10/877,621

(22) Filed: Jun. 25, 2004

Related U.S. Application Data
(60) Provisional application No. 60/494,386, filed on Aug. 12, 2003.

(51) Int. Cl. G06F 17/60

(52) U.S. Cl. 705/2; 705/1

(57) ABSTRACT

Method and systems for managing services provided by providers to recipients utilizing an interactive system are described. In one embodiment, the method includes receiving, at the interactive system, a check in request from a provider and operating the system to verify an eligibility of the recipient for services. The method also includes providing to the provider, from the interactive system, a summary of services to be provided to the recipient and receiving a check out request from the provider at the interactive system.

### CROSS REFERENCE TO RELATED APPLICATIONS

This application claims priority of Provisional Application Serial Number 60/494,386 filed Aug. 12, 2003 which is hereby incorporated by reference in its entirety.

### BACKGROUND OF THE INVENTION

Private and public sector programs sometimes require monitoring visits to a home or other locations remote from a care giver's place of business. Examples of such programs include, but are not limited to, child care programs, child protective services, adult protective services, health care, and rehabilitation services. In these types of programs, a case worker, care giver, or service provider visits a home or other location to provide the services. Performance of these services typically should be tracked to ensure that the proper services were rendered. In addition, the service providers and care givers typically bill for performance of these services, and reports are generated in connection with the services. Some of these reports may be submitted to an insurance provider who pays the service providers and care givers for providing the services to the recipients. Performing such tracking, billing, and reporting by hand is tedious, time consuming and error prone. As used herein, the term “provider” refers generally to both care givers and service providers.

In addition to the tedious and time consuming nature of paper based systems, such paper based systems can detract from the ultimate goal of providing full support to customers of such programs. For example, state Medicaid programs have historically struggled to fully support needs of the elderly and disabled. The struggle is usually due to the large volume of recipients served in non-traditional settings, which significantly impacts an agency's ability to verify services are being provided as authorized.

The federal government sometimes grants some waivers to a state's standard Medicaid processes or other state benefit program. The purpose of the waivers is to ensure development of a benefit package and/or eligibility group for Medicaid recipients that do not fit standard authorized care plans. Each waiver offers a variety of services to the elderly and disabled population through a network of service providers and care givers. In some instances, service providers may be an organization that specializes in providing these types of services, while in other instances the care givers may be family, friends or neighbors. These services are often provided in the homes of the recipients, which necessitates prior authorization by case managers.

One type of care that is overseen by case workers is sometimes referred to as consumer directed care. Consumer directed care describes programs and services where care recipients, including Medicaid recipients that do not fit standard authorized care plans, are given choices and control regarding their care. As described below in further detail, a care recipient is determined to be eligible for a periodic benefit. In consumer directed care programs, the care recipients can choose to select, manage and dismiss their service providers and care givers, as long as they remain within the monthly benefit amount. Further, they can decide which services to use, which workers to hire, and what time of day the workers will come to their residence. One example of consumer directed care would be for a meal benefit. Rather than hiring a commercial enterprise (e.g., a service provider) to provide a cooked meal to be delivered to the recipient, for which the state would pay $15.00, for example, per meal, the recipient could hire a neighbor (e.g., a care giver) to provide the benefit, to whom the state would pay $10.00 per meal.

For a recipient to receive any of the above described care services, the recipient typically must be eligible to receive such benefits, which includes at least both financial and medical assessments. When a financial determination process has been initiated, the medical assessment is also initiated. The medical assessment process determines whether quality care could be administered in the home, by family, neighbors, and friends (e.g., community-based care givers) or by service providers. When such a determination is made, the case worker, sometimes referred to as a case manager, works with the recipient, or their authorized representative, to develop a service plan, sometimes based on a periodic benefit such as Medicaid, identify one or more care givers and service providers, and arrange for care to begin. If a person is unable to make decisions for themselves regarding care and services, he/she can designate a representative. A typical representative is a legal guardian, or other legally appointed representative, an income payee, a family member, or friend.

The physical delivery location of such services makes it inherently difficult to verify authorized services are ever provided, especially if family members and/or friends are the ones being paid to deliver the authorized services. The typical system currently used to verify service delivery is a time-intensive, paper-based system that does not validate the authorized services with case management systems. The result is reliance on the honesty and accuracy of documentation provided by the recipient population, family/friend providers (care givers), and by the employees who work for the rendering service providers.

The potential risk for fraud and abuse is extremely high due to a lack of an effective way to monitor visits. Recipients may hesitate to report dissatisfaction with services for fear of losing services completely, alienating family and friends providing some of the services, or they simply may be physically unable to do so. Also, billing issues such as inappropriate billing, billing errors, and system/data entry errors negatively impact accurate and timely payment for services rendered.

### BRIEF DESCRIPTION OF THE INVENTION

In one aspect, a method of managing services provided by providers to recipients utilizing an interactive system is provided. The method comprises receiving, at the interactive system, a check in request from a provider, processing the check in request, and operating the interactive system, to verify an eligibility of the recipient for services. The method also comprises providing to the provider, from the interactive system, a summary of services to be provided to the recipient and receiving, at the interactive system, a check out request from the provider.

In another aspect, a computer-based system for tracking and managing transactions associated with care services is provided. The system comprises an interactive system, a web server, and a database server including a database. The system is configured for access by providers through at least one of the web server and the interactive system. The computer-based system is configured to receive check in requests from providers, process the check in requests, verify an eligibility of recipients for services, provide a summary of services to be provided to the recipients, and receive check out requests from the providers.

In still another aspect, a method for using an interactive voice response (IVR) system to manage services provided by a provider to one or more recipients at a recipient location is provided. The method comprises accessing the IVR system to check in the provider, retrieving the services to be provided to the recipient using the IVR system, verifying an eligibility of the recipient to receive the retrieved services using the IVR system, and accessing the IVR system to check out the provider once the eligible services have been rendered by the provider.

In yet another aspect, an interactive voice response (IVR) system to manage services provided by a provider to one or more recipients at a recipient location is provided. The IVR system is configured to receive a telephone call from a recipient location to check in the provider, provide the provider with services to be provided to the recipient, verify an eligibility of the recipient to receive the services, and receive a telephone call from a recipient location to check out the provider.

### BRIEF DESCRIPTION OF THE DRAWINGS

FIG. 1 is a diagram of a system for facilitating the tracking of provider services.

FIG. 2 is a process overview of the system of FIG. 1.

FIG. 3 is a flowchart illustrating in more detail reporting and administrative processes relating to the system shown in FIG. 1.

FIG. 4 is a chart illustrating reports that are generated by the system of FIG. 1.

FIG. 5 is a chart illustrating a bulk filing function performed by the system of FIG. 1.

FIG. 6 is a chart illustrating a user administration function.

FIG. 7 is a chart illustrating various system screens displayed by the system of FIG. 1.

FIG. 8 is a flowchart illustrating a login process into the system of FIG. 1.

FIG. 9 is a flowchart illustrating an in home check in process.

FIG. 10 is a flowchart illustrating an in home check out process.

FIG. 11 is a flowchart illustrating a client validation process.

FIG. 12 is a flowchart illustrating a provider payments process.

FIGS. 13 and 14 are a flowchart illustrating a bulk filing process.

FIG. 15 illustrates one embodiment of a welcome/login web page.

FIG. 16 illustrates an embodiment of a register for access web page.

FIG. 17 illustrates one embodiment of a register for access web page.

FIG. 18 illustrates one embodiment of a forgot password web page.

FIG. 19 illustrates one embodiment of a change password web page.

FIG. 20 illustrates one embodiment of a main menu web page.

FIG. 21 illustrates one embodiment of a maintain claim information web page.

FIG. 22 illustrates one embodiment of a filtering and sorting web page.

FIG. 23 illustrates one embodiment of an edit, delete, view claims web page.

FIG. 24 illustrates another embodiment of an edit, delete, view claims web page.

FIG. 25 illustrates one embodiment of an add claims web page.

FIG. 26 illustrates one embodiment of an add claims web page.

FIG. 27 illustrates one embodiment of a claim confirmation web page.

FIG. 28 illustrates one embodiment of a missed visit search criteria web page.

FIG. 29 illustrates one embodiment of a missed visit search results web page.

FIG. 30 illustrates one embodiment of a user administration web page.

FIG. 31 illustrates one embodiment of a validate claims web page.

FIG. 32 illustrates one embodiment of add time card web page.

FIG. 33 illustrates one embodiment of an add time card information web page.

FIG. 34 illustrates one embodiment of a time card confirmation web page.

FIG. 35 illustrates one embodiment of a bulk filing option selection web page.

FIG. 36 illustrates one embodiment of a bulk filing search entry web page.

FIG. 37 illustrates one embodiment of a bulk filing select service web page.

FIG. 38 illustrates one embodiment of a bulk filing service list selection web page.

FIG. 39 illustrates one embodiment of a bulk filing add client web page.

FIG. 40 illustrates one embodiment of a bulk filing confirmation web page.

FIG. 41 illustrates one embodiment of a delete user web page.

FIG. 42 is one embodiment of a screen resolution page.

FIG. 43 is one embodiment of a incompatible browser page.

FIG. 44 is one embodiment of a cookies check page.

FIG. 45 is one embodiment of a technical difficulties page.

FIG. 46 is one embodiment of a maintenance page.

FIG. 47 is one embodiment of a timeout page.

### DETAILED DESCRIPTION OF THE INVENTION

Although the systems and methods are sometimes described herein in the context of Medicare and Medicaid programs, the systems and methods are not limited to practice in connection with only Medicare and Medicaid programs and can be used in connection with other private and public sector programs. Generally, the systems and methods are believed to be particularly beneficial in connection with programs that require monitoring visits to a home or other locations remote from a supervisor and are generally directed to facilitating the provision of public and private sector home or community based services.

More specifically, a system is provided which has the technical effect of facilitating tracking and management of at-home and community-based care, including consumer directed care. The system enables traveling care givers (e.g., an employee of a service provider) and care givers associated with the recipient, for example, a family member, a neighbor, or other friend, to access a voice response system by dialing a telephone number, typically a toll-free number, from a service recipient's home. The voice response system allows a care giver to check in before rendering services, select services that will be provided, verify eligibility, and check out once services are complete. Eligibility and services are validated, treatment time is tracked, and billing/claims submission is facilitated electronically. Additionally, the system is able to use presence management technology, for example, automatic number identification (ANI), a global positioning system (GPS) or other location based service, to verify the care giver is at the recipient's location, thereby increasing the likelihood that the services were actually provided.

The system includes reporting and analysis, offering agency access to provider activity, client activity, and meaningful exception reporting statistics, such as missed visits, unauthorized visits, incorrect location, or incorrect services. Data and analysis tools and interfaces are also accessible by the service provider community to help manage staff, schedules, claims, provide reports, and retrieve data.

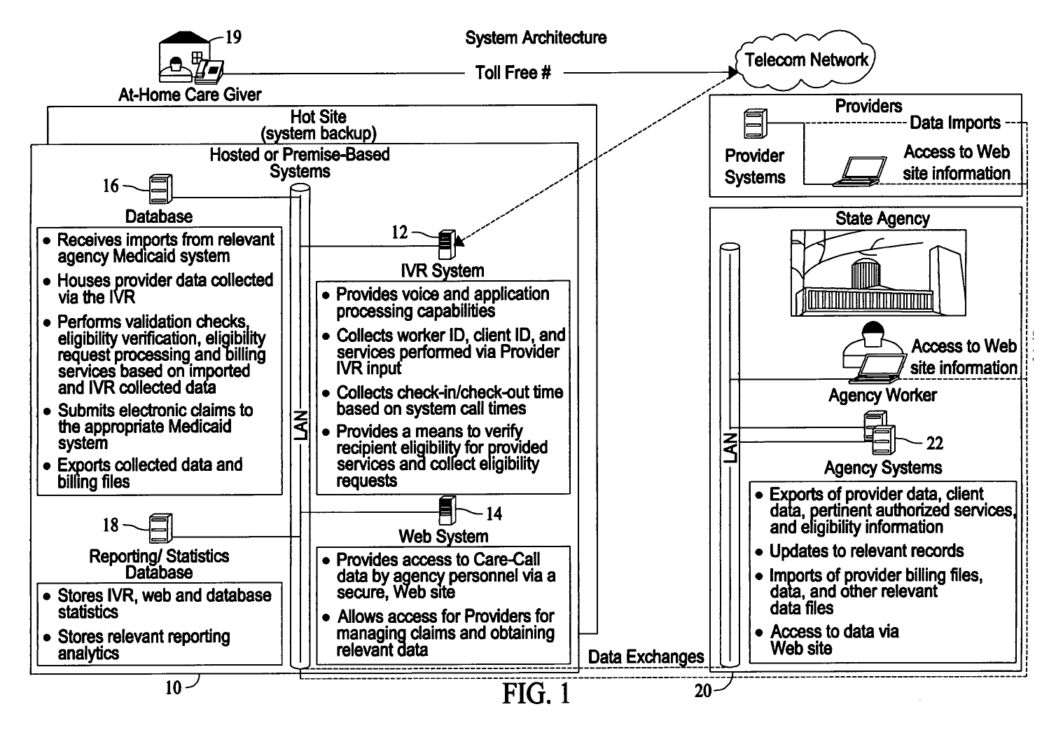

FIG. 1 illustrates one embodiment of a computer based system 10. In the embodiment illustrated, system 10 includes an interactive voice response (IVR) system 12 and a web-based system 14 for running web applications. System 10 further includes a database 16 and an administrative application in the form of a reporting and statistics database 18, and reporting utilities. Other methods/devices are contemplated for use in entering, managing and reporting on services and program data utilizing system 10, including but not limited to, PDA's, GPS, tablet computers, web access, laptop computers, and bar coding. In an example embodiment, the applications are based on the Microsoft Windows 2000 server platforms and utilize a network architecture. Microsoft and Windows 2000 are registered trademarks of Microsoft Corporation, Redmond, WA. In one example embodiment, application development is performed utilizing C++, Visual Basic and Visual C++ programming languages and Web pages are presented through Active Server Pages (ASP.NET) via an Internet Information Server (IIS). In the example embodiment, a SQL Server, using Structured Query Language (SQL) in a relational-table format, powers databases 16 and 18 that form a portion of system 10. Reports can be generated for each aspect of the system.

Database servers 16 and 18 provide the data relationships, validation, security, host integration, and overall data consolidation services for system 10. Database servers 16 and 18 are highly robust and reliable, offering storage capacity that allows for scaleable volumes of data. Database servers 16 and 18 are often clustered together for greater reliability. In addition, database servers 16 and 18 may contain backup tape devices (not shown) for periodic backups and storage of data. The described system leverages the Microsoft SQL Server environment to provide a reliable relational database structure for the application. The SQL Server environment facilitates necessary data interactions, such as file imports/exports, as well as real-time open database connectivity (ODBC) connections to applications handled by the system.

Database servers 16 and 18 also perform several functions beyond data storage. Data is first imported and consolidated into the data schema for access by the applications run on system 10, for example, access by a care giver 19 and/or a provider of care. As records are accessed from database servers 16 and 18 based on ID inputs of care givers 19, service providers, or administrators, inputs are validated and data is sent to the calling application as requested. In addition, database servers 16 and 18 authorize data to be written to the databases. The databases of database servers 16 and 18 form one central repository of information that can be accessed by either IVR system 12 and web-based system 14. Data maintained by the databases is secure based on read/write access privileges that are determined based on user ID inputs. Finally, all exports to agency systems are defined based on the action of the databases.

IVR system 12 and other access technologies referred to herein enable care givers 19 to access system 10 during the at-home visits upon the commencement and conclusion of the service. In one embodiment, IVR system 12 is based on open-systems technology that combines rapid-development tools with advanced voice and data-access technology to provide efficient, easy-to-use applications. In one example, IVR applications are hosted on a Windows 2000 server. System 10 is also scalable to call volumes needed to be supported from at-home provider call-ins.

As one example of an access method, IVR system 12 is completely automated and provides read/write capabilities to database servers 16 and 18. Data can be written via dual tone multi-frequency (DTMF) tones from the user's keypad or via advanced technology such as voice recognition for alphanumeric characters. The IVR application of IVR system 12 provides a menu of options and directions to guide the providers through the eligibility verification, selection of services to be provided, check in, and check out processes. Data fields can be validated through the application as well.

A base script and functionality is provided via the standard system offerings, and IVR system 12 can be customized using a variety of script options and advanced technologies. For instance, specialized functions can be integrated into the IVR application depending on needs that an agency desires the application to address. Advanced technologies that can be supported include database lookups, ANI, dialed number identification service (DNIS), GPS, voice recognition, text-to-speech, TDD, fax back, fax-on-demand, and voice messaging.

Both agency and provider access to data can be enabled through a secure Internet, PDA, mobile or other types of applications. Web system 14 includes web servers that interact with database servers 16 and 18 through business objects, which connect to the database servers 16 and 18 via standard ODBC connections. The Web application on web system 14 is made available to authorized users via an Internet Information Server (IIS). The application is developed utilizing ASP.NET pages that allow for an interactive Web session. Web system 14 is responsible for all session processing and access to the Internet address.

The administrative application (accessed, for example, through the Web, PDA, or other device) serves both the agency and provider communities. The agency is able to access claims information, generate management reports, and generate service files that help analyze the activities of the provider's service delivery as further described below. Service provider and care givers 19 are able to access pending service interactions, download data (as authorized) for their own records, generate reports and manage claims. The ability to provide users with this data results in efficient operations for service providers, care givers and agency staff.

The Web applications are protected through several security methodologies, including, but not limited to, firewalls, Secure Socket Layers (SSL), encryption keys, Network Address Translation (NAT), digital certificates and other accepted security practices.

Beyond the program reports that are generated via the Web application, reports on a variety of system functions can be provided from system 10. Statistical data, such as Web hits, call summaries, service levels, port utilizations, and various event analyses, is gathered and formatted in order to analyze system performance. Reporting parameters are defined in order to analyze the statistics that mean the most to a particular agency. Upon the selection of a particular report, date and time ranges, events, and specific system parameters can be selected and reported upon in standard report layout templates. These reports facilitate ensuring that the system is maintaining the appropriate service levels to the agency, care givers, service providers, and the recipients of the services detailed herein.

In carrying out the functions of the applications, data and applications must interact between the systems. Requests are received from Web system 14 and IVR system 12 from care givers 19, service providers and agency users. These requests are processed and requests are made to the database via an ODBC connection for data storage and access.

System 10 also interacts with external systems in a variety of ways. Examples include daily, weekly, or monthly imports/exports of data to and from a state agency 20 having a state agency system 22. As used herein, state agency refers to, but is not limited to any Federal, state, local, and/or any other public or private agency that is administering such services to recipients.

Accessing and/or updating agency files within state agency system 22 are a common form of interaction. These data exchanges can occur using FTP processes or via secure HTTP utilizing XML data formats. In addition, and as examples, the exchanges can include Web Services, Web Form Entry, File import/extract using EDI, and XML. Data file formats are predefined based on field lengths, data types, and data structure. In addition, real-time interactions can occur using open connectivity standards, screen scraping, or advanced Web-to-host technology.

For both data center hosted and premise-based versions of system 10, redundancy and disaster recovery is important. The system is designed to support multiple layers of redundancy that is both built into the application and/or the infrastructure that allows it to meet the needs of a true 24 hours a day, 7 days a week, 365 days a year operation.

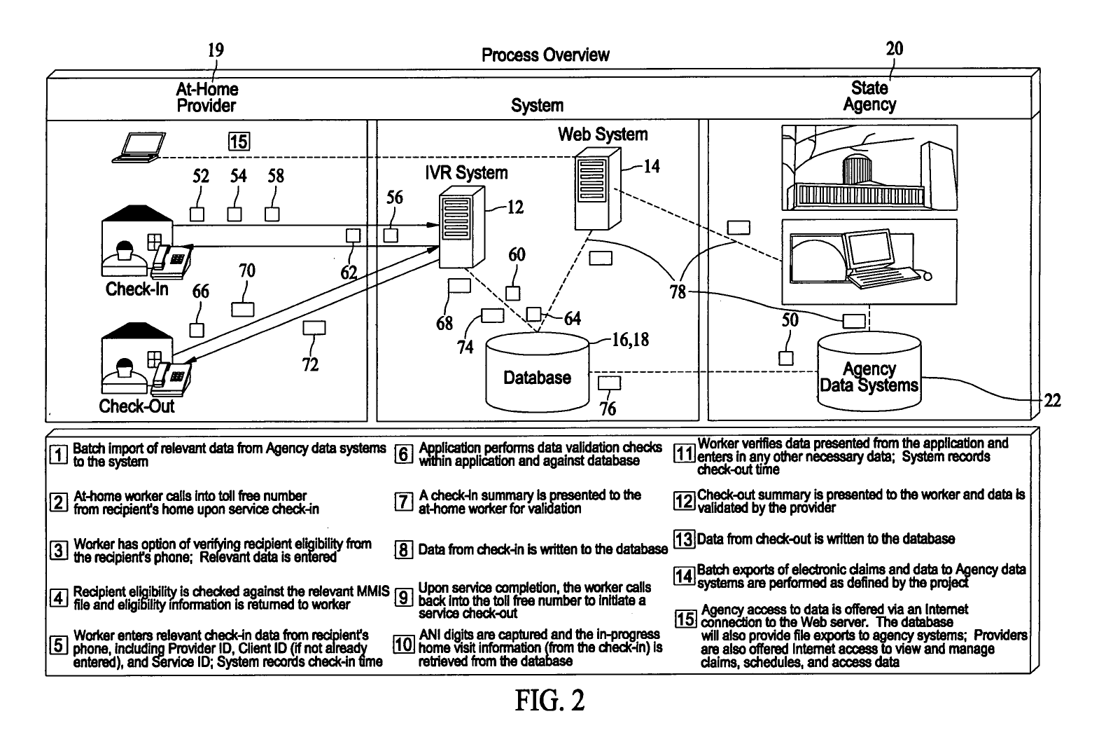

FIG. 2 illustrates a detailed process overview for system 10 (shown in FIG. 1), including user and system points of interface. The diagram illustrates the process as an integrated set of actions that occur as a step-by-step process. To prepare for the providing of services, a batch import of relevant service data is sent 50 from agency systems 22 to databases 16, and 18. A care giver 19 calls 52 into a toll free telephone number from a recipient's home to check in. Care giver 19 has an option of verifying 54 recipient eligibility from the recipient's telephone, and the relevant data is entered by care giver 19 and received by IVR system 12. Recipient eligibility is checked 56 as IVR system 12 access databases 16 and 18 and eligibility data is returned to care giver 19. Care giver 19 then enters 58 relevant check in data from recipient's telephone, including one or more of a provider identification, a client identification, and a service identification and IVR system 12 records a check in time.

System 10 then performs 60 data validation checks against databases 16 and 18, and a check in summary is provided 62 to care giver 19 for validation. Data from the check in is written 64 to databases 16 and 18. Upon completion of the services to be provided, care giver 19 calls the toll free number to initiate 66 a service check out. In one embodiment automatic number identification is utilized to capture the digits and in progress service information is retrieved 68 from databases 16 and 18. Care giver 19 verifies data provided from databases 16 and 18 and enters any other necessary data, and IVR system 12 records 70 a check out time.

A check out summary is presented 72 to care giver 19 and data is validated by IVR system 12. Data from the check out is written 74 to databases 16 and 18. Batch exports of electronic claims and data are sent 76 to agency systems 22. In one embodiment, a portion of the electronic claims and data are Medicaid claims that are formatted as a HIPAA compliant electronic data interchange transaction. In the embodiment, system 10 determines if the recipient includes third party liability for the provided services and generates two electronic data interchange files, one for those recipients that have a third party liability and those recipients that do not have a third party liability for their claims. Agency 20 is able to access 78 additional data related to the provided services via the Internet. In addition, databases 16 and 18 are utilized in the export of files to agency system 22, including the above described electronic data interchange files. Service providers may also utilize the Internet to view and manage claims, schedules, and service data.

As described above, one primary interface to system 10 for at-home care givers 19 is the Interactive Voice Response (IVR) system 12. While described in terms of IVR, it is to be understood that the process is expandable to include the previously identified access technologies, including but not limited to, PDA's, GPS, location based services, tablet computers, web access, laptop computers, and bar code readers. Upon check in, care giver 19 calls a toll-free number to perform check in functions. IVR system 12 guides care giver 19 through the service process.

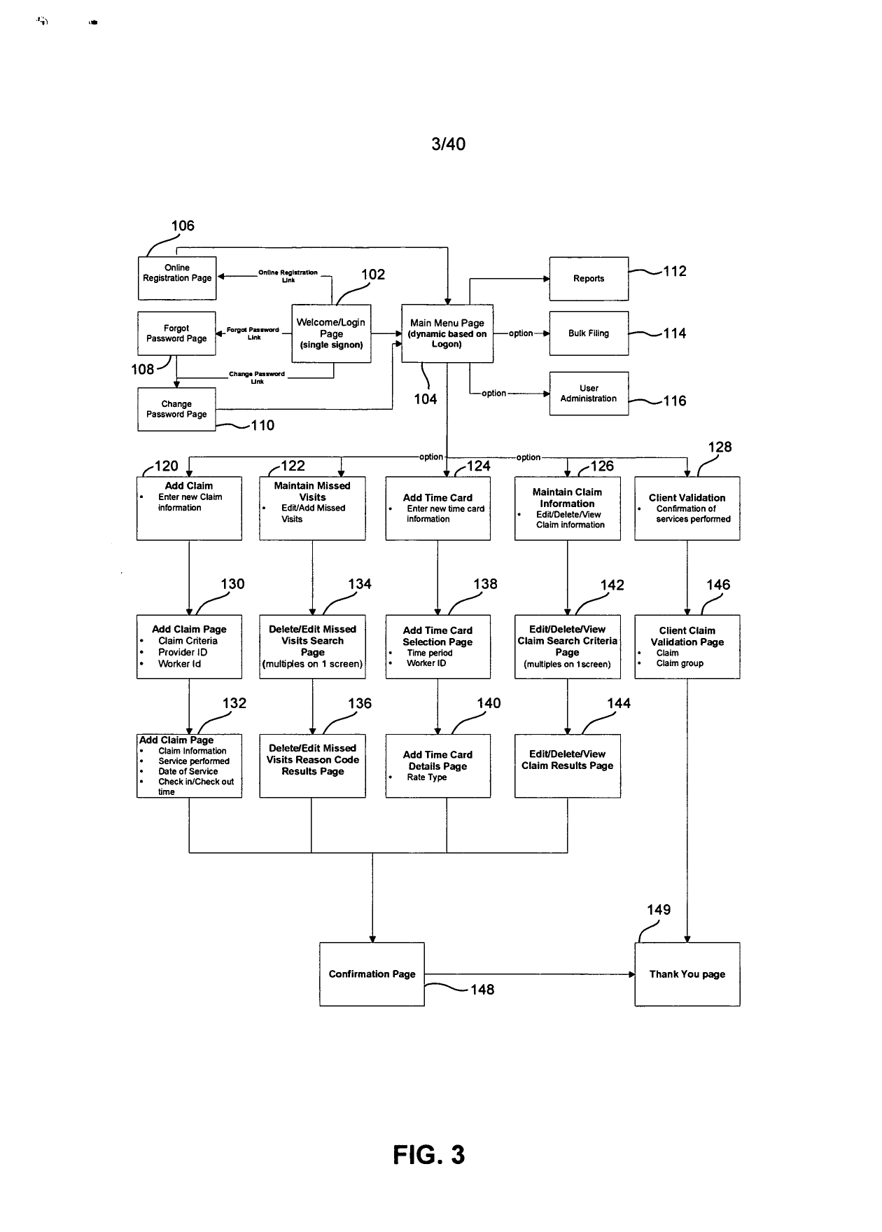

Although a script can be customized for each unique client, the flowcharts of FIGS. 3-9 illustrate an application script for an at-home care giver IVR application, including a product web flow and a product IVR flow. The IVR application facilitates the at-home care service tracking, billing, and reporting. Specifically referring to FIG. 3, flowchart 100 illustrates in more detail reporting and administrative processes relating to system 10 (shown in FIG. 1). Specifically, upon accessing system 10, a welcome/login page 102 is presented to a user. Upon a successful login, a user is presented with a main menu page 104. In addition, from welcome/login page 102, a new user may register for access to system 10 from online registration page 106 and initiate steps for re-logging in from a forgot password page 108. A user may select a new password for access to system 10 from a change password page 110.

From main menu page 104, a user can select to generate reports 112, select a bulk filing option 114, and select to perform user administration function 116. Reports 112 include, but are not limited to, client activity reports, provider activity reports, exceptions reports, claim detail —by case manager reports, account statement reports, savings account reports, current account balance reports, expenditures reports, 65% budget spent reports, actual units less than authorized units reports, claim detail—by client reports, claim detail—by provider reports, missed visits reports, provider invoice reports, claim exceptions—by provider reports, claim exceptions—by client reports, plan schedule reports, and claim history reports as further described below. Reports 112 further include, but are not limited to, billing invoices, provider schedules, and time and attendance. With respect to user administration function 116, a user can add and delete users and access a confirmation page as also further described below. From main menu page 104, the user can add claims 120, maintain missed care provider visits 122, add time cards 124, maintain claim information 126, and perform client validation 128.

When selecting to add claims 120, a first add claims page 130 provides a user with an interface to enter claim criteria, a provider identifier, and a worker identifier. A second add claims page 132 provides a user with an interface to enter claim information, services performed, a date of service, and a check in and check out time. When selecting to maintain missed visits 122, the user is provided with either a delete/edit missed visits search page 134 or a delete/edit missed visits reason code results page 136. Delete/edit missed visits search page 134 provides a user with an interface for deleting and editing missed visits which are detailed after entry via missed visits reason code results page 136.

When selecting to add time cards, an add time card selection page 138 provides a user with an interface to enter a time period and a worker identifier. An add time card details page 140 provides a user with an interface to enter a rate type to a time card. When selecting to maintain claim information 126, editing, deletion, and viewing of claims is accomplished from claim search criteria page 142 with results of the search being presented to a user on a claim results page 144. When selecting client validation 128, a client claim validation page 146 allows the user to enter data relating to the claim and the claim group. After viewing any of the above described pages excepting the client and claim validation pages 128 and 146 a user is provided with a confirmation page 148. Both confirmation page 148 and client and claim validation pages 128 and 146 exit to a thank you page 149, presented to a user upon logout.

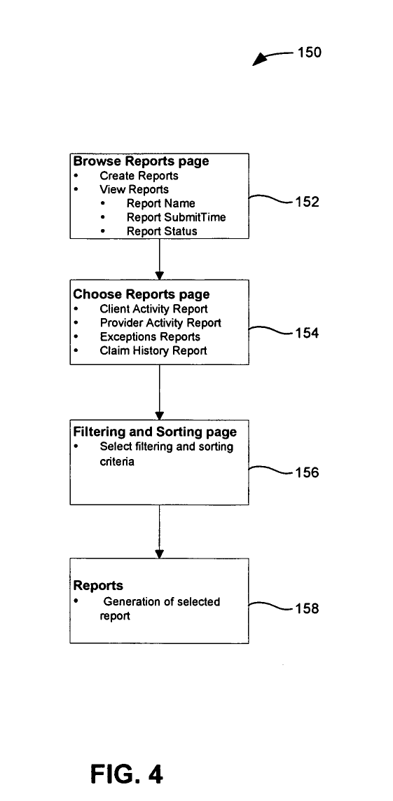

FIG. 4 is a chart 150 illustrating reports 112 (shown in FIG. 3) that are generated by system 10 (shown in FIG. 1). By accessing a browse reports page 152, a user can create and view reports by entering one or more of a report name, a report submit time and a report status. A choose reports page 154 allows a user to select from a client activity report, a provider activity report, exceptions reports, and a claim history report. Other embodiments allow for selection of additional reports from reports page 154 including, but not limited to, claim detail—by case manager reports, account statement reports, savings account reports, current account balance reports, expenditures reports, 65% budget spent reports, actual units less than authorized units reports, claim detail—by client reports, claim detail—by provider reports, missed visits reports, provider invoice reports, claim exceptions—by provider reports, claim exceptions—by client reports, and plan schedule reports. A filtering and sorting page 156 allows a user to select filtering and sorting criteria for the reports to be created and/or viewed. A reports page 158 is accessed to generate the selected report.

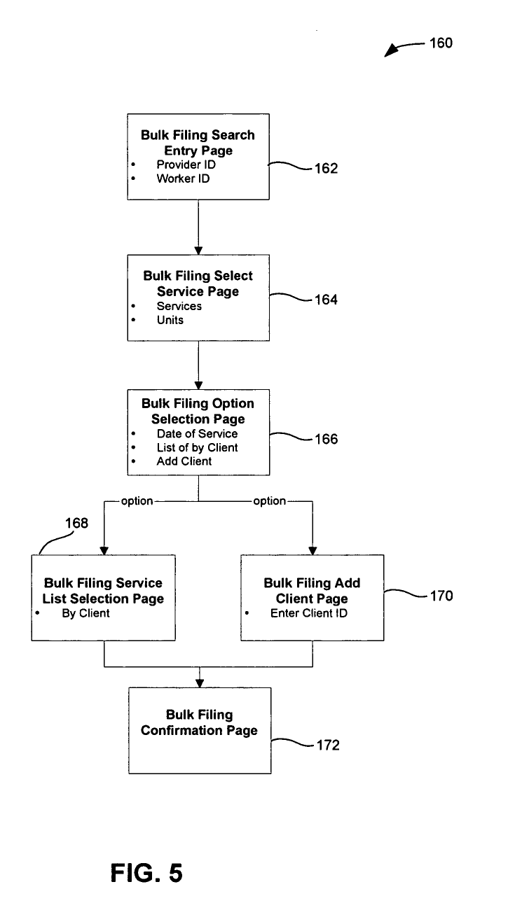

FIG. 5 is a chart 160 illustrating a bulk filing function 114 (shown in FIG. 3) that is performed by system 10 (shown in FIG. 1). A bulk filing search entry page 162 provides a user an interface for entering one or more of a provider identifier and a worker identifier. A bulk filing select service page 164 is an interface allowing a user to select services and units. A bulk filing option selection page 166 is an interface allowing a user to select a date of service, a by client listing, and add new clients. A bulk filing service list selection page 168 provides a by client listing and a bulk filing add client page 170 allows addition of clients to bulk filing by entry of their client identifier. A bulk filing confirmation page 172 is also provided.

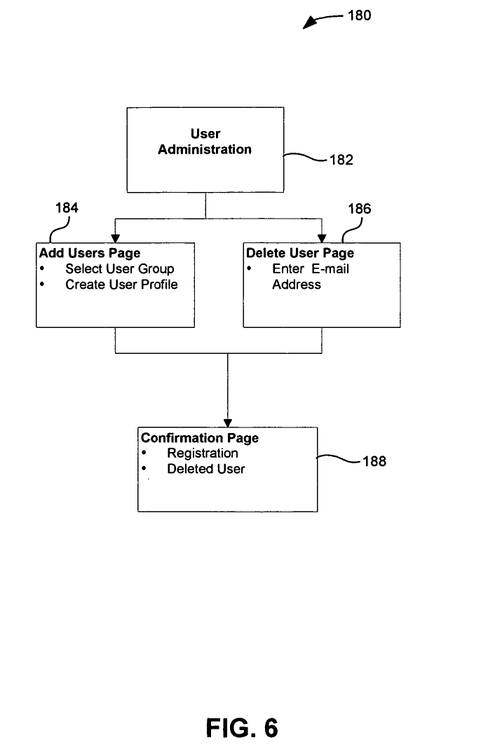

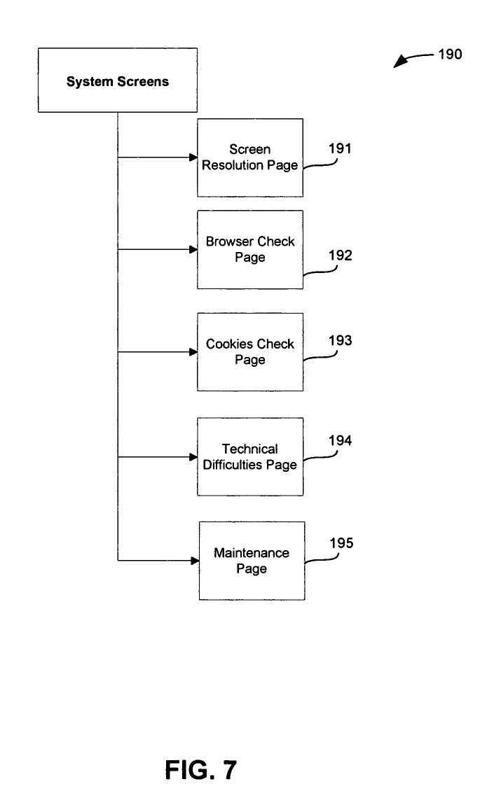

FIG. 6 is a chart 180 illustrating a user administration fiction 116 (shown in FIG. 3) that performed by system 10 (shown in FIG. 1). From a user administration screen 182 an administrative user can select to add or delete users. An add users page 184 provides an interface for selecting a user group and creating user profiles. From a delete user page 186, an administrative user enters an E-mail address of a user to be deleted. A confirmation page 188 illustrates a completed registration for new users and further illustrates which users have been deleted. FIG. 7 is a chart 190 illustrating various system screens displayed by system 10 (shown in FIG. 1) including a screen resolution page 191, a browser check page 192, a cookies check page 193, a technical difficulties page 194, and a maintenance page 195.

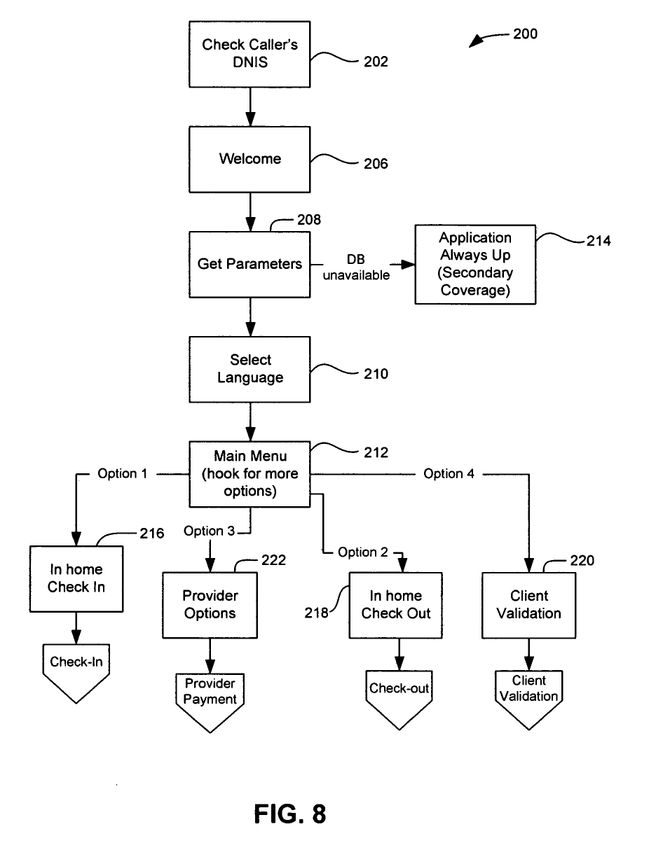

FIG. 8 is a flowchart 200 illustrating a login process into system 10 from a remote site and selection of services by a care giver. System 10 receives a call in from a care giver, and a dialed number identification service (DNIS) is checked 202 to attempt to identify the telephone number that the caller dialed. DNIS is a telephone service that identifies for the receiver of a call the number that the caller dialed. It is a common feature associated with 800 or 900 type telephone numbers. If there are multiple 800 or 900 numbers to the same destination, DNIS tells which number was called. DNIS works by passing the touch tone digits to the destination where a special facility can read and display them or make them available for call center programming.

Whether or not DNIS is available, the dialer receives 206 a welcome message. Parameters regarding the services to be provided by the care giver to the recipient are received 208 from a database and a language is selected 210 by the care giver. Upon selection 210 of a language, a main menu is provided 212 to the care giver. If the database is unavailable, secondary coverage 214 is provided so that system 10 is always available to care givers. The order described above is by way of example only. For example, selection 210 of a language before receipt 208 of parameters is contemplated.

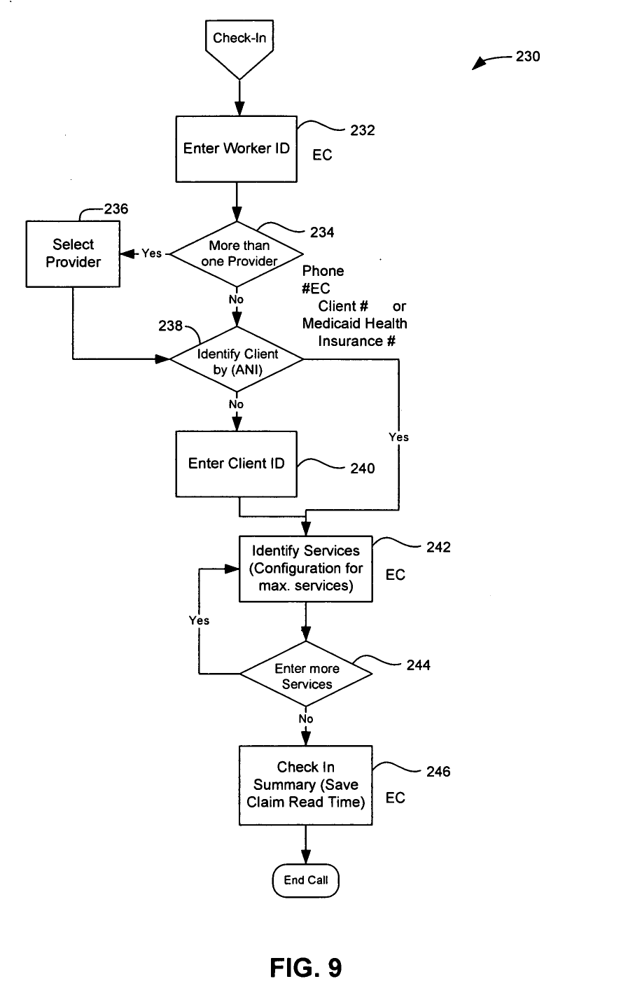

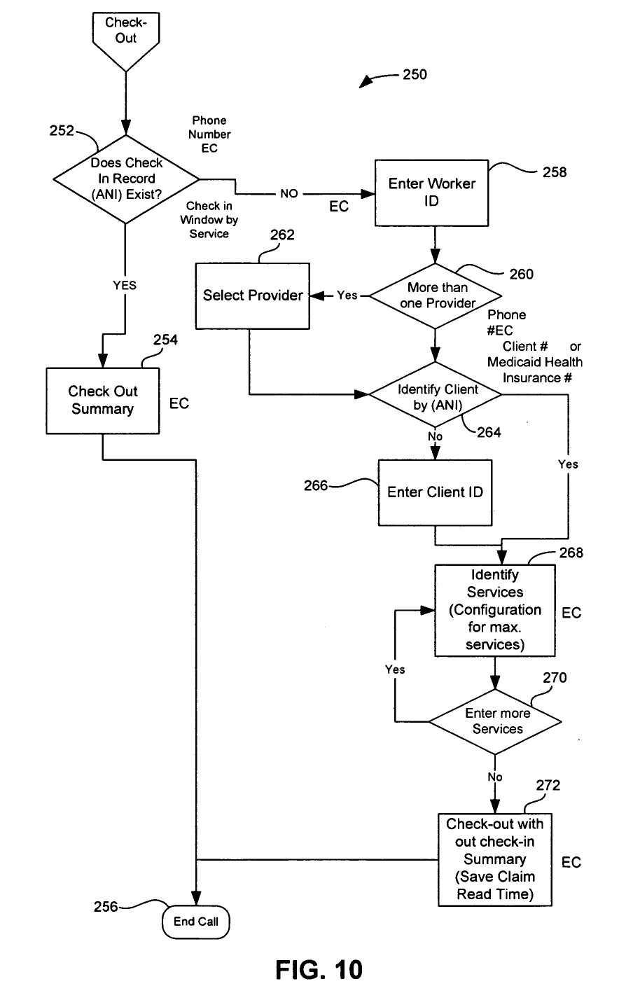

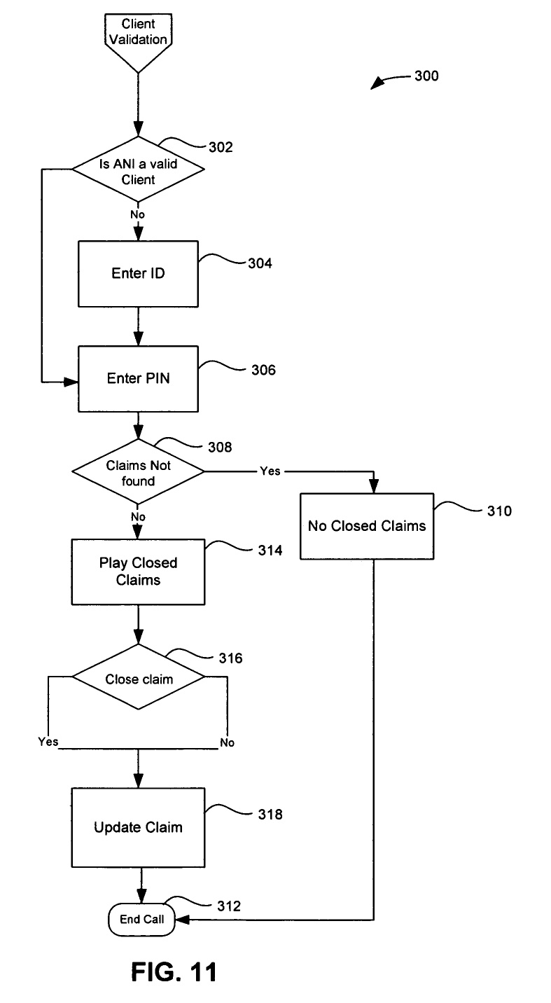

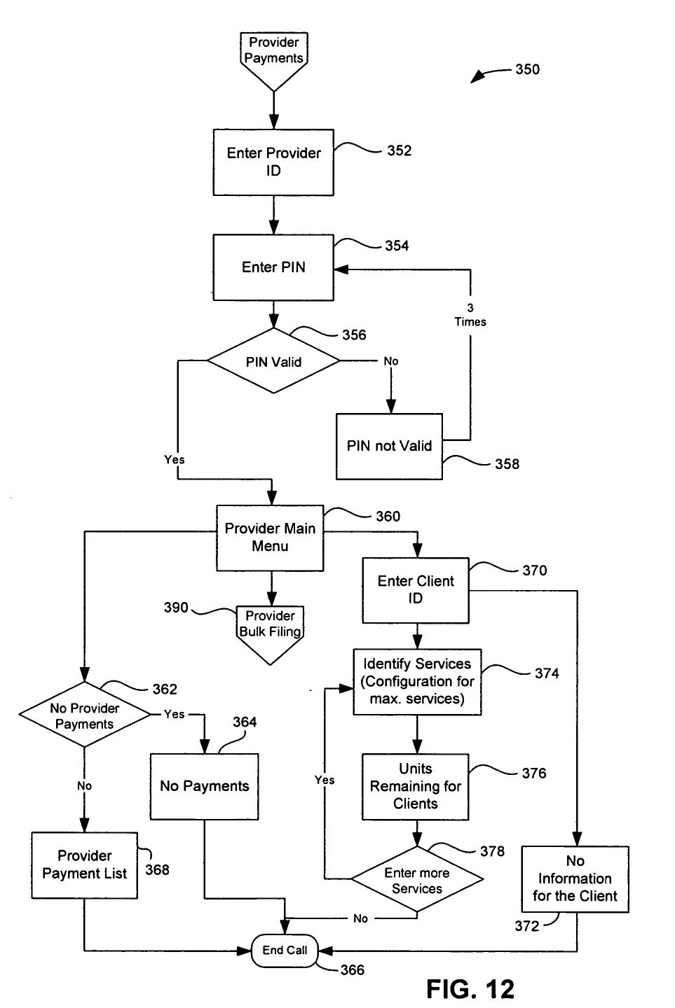

From the main menu, a care giver can select care options, including, but not limited to, in home check in 216 (shown in FIG. 9), in home check out 218 (shown in FIG. 10), client validation 220 (shown in FIG. 11), and provider options 222 (shown in FIG. 12).

FIG. 9 is a flowchart 230 illustrating an in home check in process performed by a care giver (continued from FIG. 8). The care giver enters 232 a worker identification number. The term “worker identification number” is utilized herein to describe an identification number for an employee of a commercial care services provider. However, in the consumer directed care context, the term further describes an identifier for those individuals (i.e., family friends, and neighbors) that are registered as care providers, for one or more care recipients, utilizing system 10. Such individuals and those that are employees of the commercial care services provider are collectively referred to herein as care givers. If the care giver provides services for more than one services provider 234, the provider for the contemplated services is entered 236. The client (e.g., recipient) is then identified 238 by one or more of the client telephone number, a client number, a Medicaid health insurance number, or another identifier that can be utilized to identify the client to system 10. As used herein, the term client refers to an entity, usually a person, that is a recipient of services administered by a care giver through a services provider. System 10 first attempts to identify 238 the client utilizing automatic number identification (ANI). If such an attempt at client identification is unsuccessful, a client identifier is entered 240. System 10 identifies 242 services that are to be administered by the care giver, and further provides the care giver an option to enter 244 additional services. When any additional services have been entered 244, system 10 provides the care giver with a check in summary 246.

FIG. 10 is a flowchart 250 illustrating an in home check out process performed by a care giver (continued from FIG. 8). System 10 (shown in FIG. 1) first determines 252 whether or not a check in record exists. In one embodiment, determination 252 is accomplished utilizing ANI. If the check in record exists, a check out summary is provided 254 and the call is ended 256. If a check in record does not exist, the care giver enters 258 a worker identification number. If the care giver provides services for more than one services provider 260, the provider for the contemplated services is entered 262. The client is then identified 264 by one or more of the client telephone number, a client number, a Medicaid health insurance number, or another identifier that can be utilized to identify the client to system 10. System 10 first attempts to identify 264 the client utilizing automatic number identification (ANI). If such an attempt at client identification is unsuccessful, a client identifier is entered 266. System 10 identifies 268 services that should have been administered by the care giver, and further provides the care giver an option to enter 270 additional services. When any additional services have been entered 270, system 10 provides the care giver with a check out without check in summary 272, and the call is ended 256.

FIG. 11 is a flowchart 300 illustrating a client validation process (continued from FIG. 8). To validate a client, ANI is used to determine 302 if the call from number is that of a valid client. If not a valid client, an identification number is entered 304 and a personal identification number (PIN) is entered 306. If the determination 302 indicates a valid client, only a PIN is entered 306. After PIN entry 308, system 10 determines 308 if there are any closed claims for the client. If there are no closed claims 310, the call is ended 312. If there are one or more closed claims for the client, those closed claims are provided 314 to the care giver, who determines whether or not to close 316 each individual claim. Once the claim has been updated 318 by the care givers, the call is ended 312.

FIG. 12 is a flowchart 350 illustrating a provider payments process. With respect to providing payments to care providers, a care giver enters 352 a provider identification number and further enters 354 a PIN. System 10 (shown in FIG. 1) determines 356 if the PIN entered 354 is valid. If not valid 358, a user is given, in one embodiment, three opportunities to enter 354 a valid PIN, after which they are preventing from accessing system 10. When a valid PIN is entered 354, the care giver or provider receives 360 main menu selections. With a selection of a payment list, system 10 determines 362 if no provider payments are to be made 364. If there are no payments are to be made 364, the call is ended 366. If payment are to be made, a payment list is provided 368 and the call is ended 366.

With selection of client units from the received 360 main menu selections, a client identification number is entered 370. If no information is available 372 for the entered 370 client identification number, the call is ended 366. If the client identification number is recognized by system 10, services for that client are identified 374. In addition, a number of units of each individual service for the client are provided 376, and the provider is able to enter 378 more services for the client, if they are so entitled, otherwise, the call is ended 366. A bulk filing option 390 is also selectable from the received 360 main menu selections.

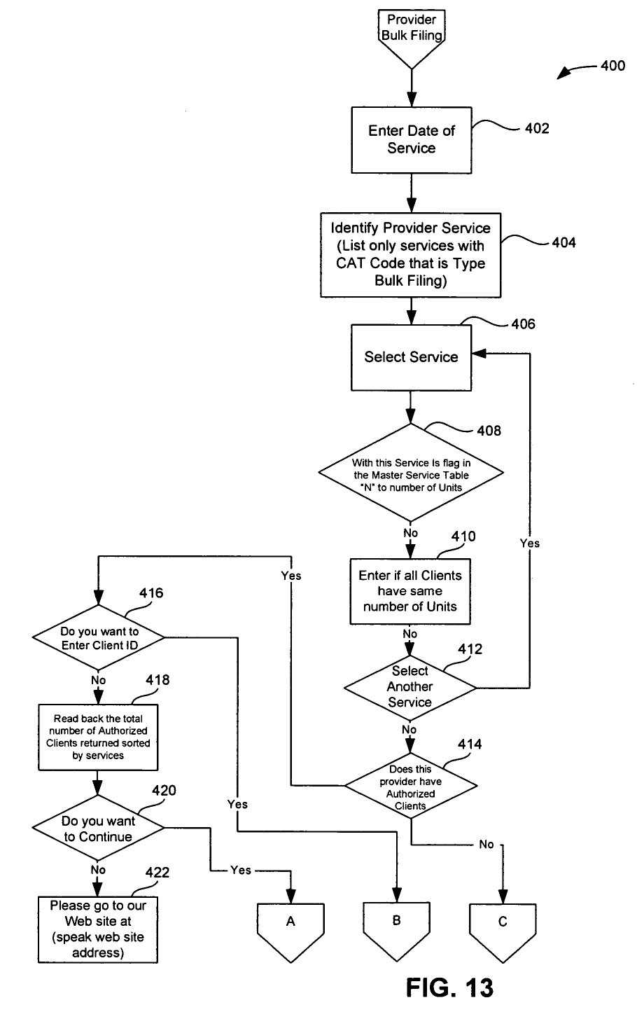

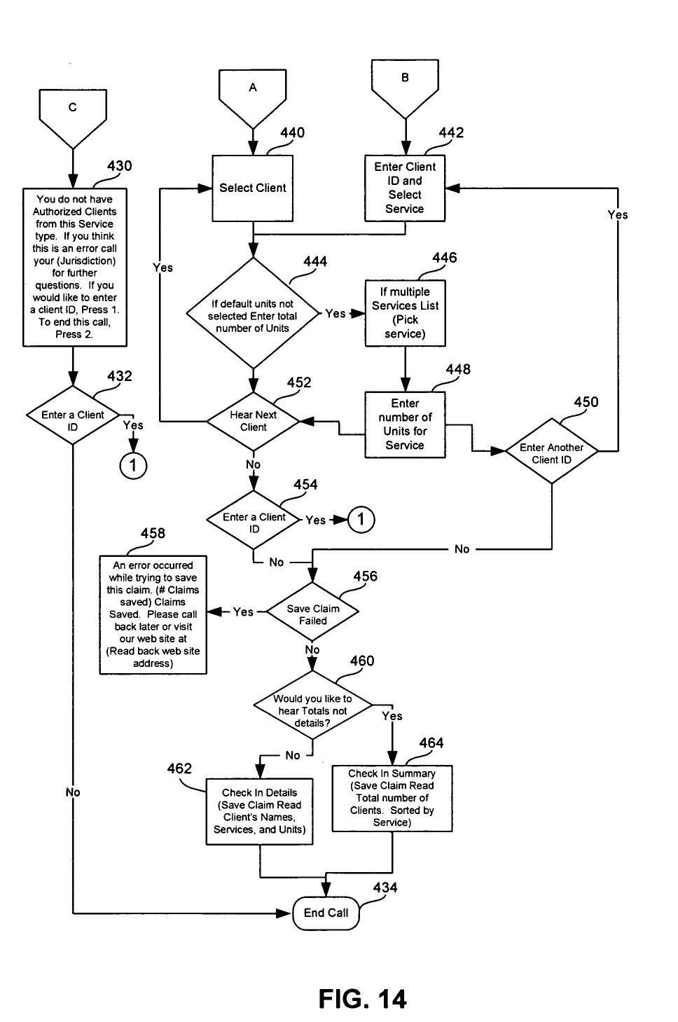

FIGS. 13 and 14 are a flowchart 400 illustrating a bulk filing process. The bulk filing process allows provider agencies to enter claims for certain services where they may need to enter the actual number of units provided (e.g., home delivered meals) or answer yes/no to questions as to whether service was provided (i.e., adult day care, personal emergency response system installation). In each of these services, the provider is given an option to enter claims for all authorized clients at one time instead of entering them individually for each client through the check-in/check-out process.

To initiate the bulk filing process, a date of service is entered 402 and the provider service is identified 404. A provider service is selected 406 and a master service table is checked 408 to determine the number of units of the service to be provided, as further described below. If all clients do not have the same number of units 410 to be provided, another service is selected 412. If the provider has authorized clients 414, a query as to whether entry 416 of a client identifier is desired is provided. If not, the user is provided 418 a total number of clients authorized sorted by the services to be provided. If the user does not want to continue 420, they are directed to a web site address 422.

If the provider does not have authorized clients 414, (now referring to FIG. 14) a message indicating that the provider does not have authorized clients is displayed 430. The displayed 430 message provides the user an opportunity to enter 432 a client identifier or end 434 the call. As illustrated, the user is provided with various opportunities to select 440 a client or enter 442 a client identifier and select a service. If a default number of service units is not selected, a total number of service units is entered 444, with an option to pick the services applicable from a multiple services list 446 and entry of the number of units for service 448 and another client identifier may be entered 450. If a default number of service units is selected, the next client is heard 452 and a client identifier entered 454.

If a client identifier is not entered (450, 454), a failure message relating to the failed claim save 456 is displayed 458. If the claim is properly saved, an option is provided to the user to hear totals 460, for example, check in details 462 or a check in summary 464, and the call is ended 434.

As described above, system 10 supports check in, check out, and bulk filing processes. In addition, recipient eligibility can be verified by the care giver, as described above, via IVR or using other access technologies identified herein. Verification of eligibility is a useful process embodied within system 10 which is based on data that can be accessed by system 10. Claims and billing processes are managed by system 10 and initiated from the data collected through IVR. Data input via the IVR is also stored as part of the data system for future access by care givers, service providers and agency workers.

Service providers also have access to relevant data for their own use. The data is provided via a Web interface and assists service providers in better managing claims, billing, staffing, payments, and interactions with the agency. In addition, service providers may receive an import of authorized data into their own systems. Service providers can register authorized at-home care givers and access reports and data on a subscription basis. This includes the ability to view live data, download data, schedule and manage staff, facilitate fiscal management and data reconciliation, and manage cases. Registrations, subscriptions, and associated payments are enabled through the Web site or other access methods. ACH transactions and credit card purchases can be initiated via the secure Web site.

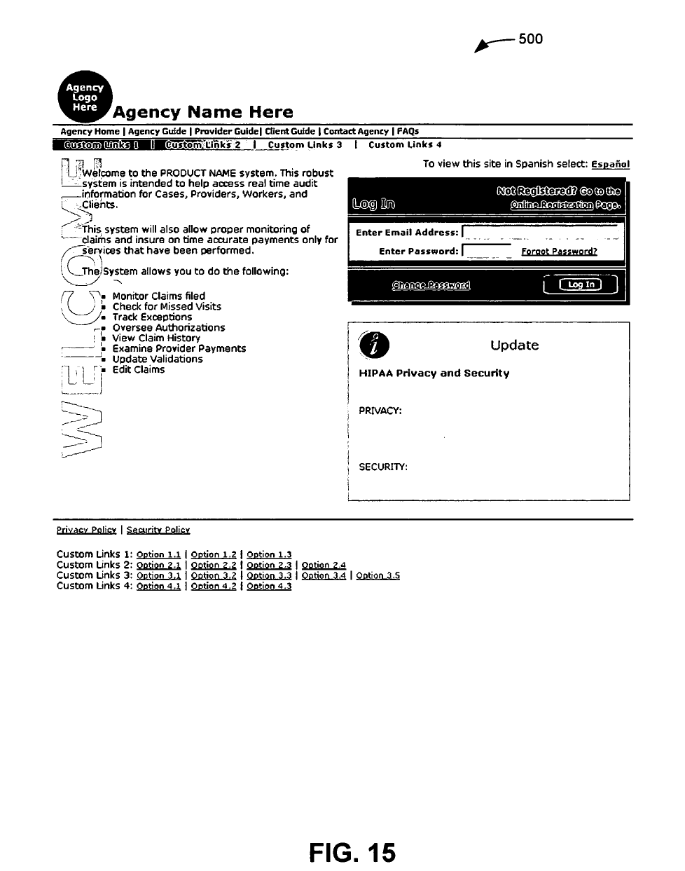

FIGS. 15-47 are example screen shots of various user interface pages that can be utilized in connection with the above described systems and processes. For example, an agency can interface with system 10, for example, through an administration application, which can be accessed through the Web or other technologies (for example PDA, mobile devices). The administration application allows for the adding, editing, and analysis of claims and provider activity.

FIG. 15 illustrates one embodiment of a welcome/login web page 500. Welcome/login web page 500 allows a registered user of system 10 (shown in FIG. 1) to log in to access the capabilities of system 10. Welcome/login web page 400 illustrates one possible user interface for welcome/login page 102 (shown in FIG. 3). Welcome/login web page 500 prompts a user to enter their email address and a password. One link is provided which allows a user to access another web page to change their password. Another provided link allows a user to access still another web page if they have forgotten their password. In the embodiment illustrated, welcome/login web page 500 includes messages providing updates to the users of system 10, for example and as shown, updates relating to the health insurance portability and accountability act of 1996 (HIPAA).

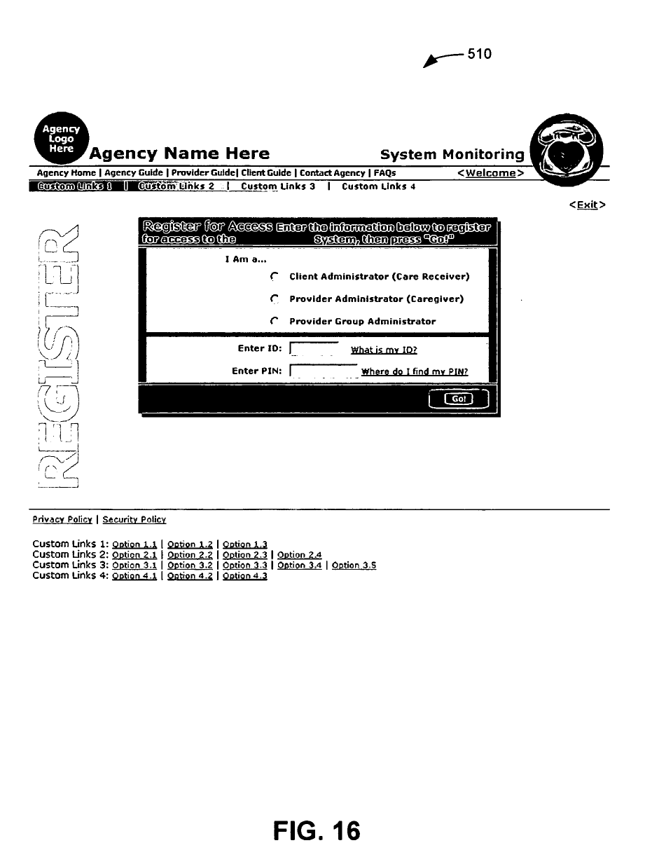

FIG. 16 illustrates an embodiment of a register for access web page 510. Register for access web page 510 allows a prospective user of system 10 (shown in FIG. 1) to enter registration information. For example, in the embodiment illustrated, register for access web page 510 prompts a user to select whether they are a client (care receiver), a provider (care giver), or if they represent a group of service providers. A user further enters both an identification number, and a personal identification number, in the embodiment shown. In one embodiment, register for access web page 510 constitutes a first portion of a registration process and illustrates one possible user interface for online registration page 106 (shown in FIG. 3).

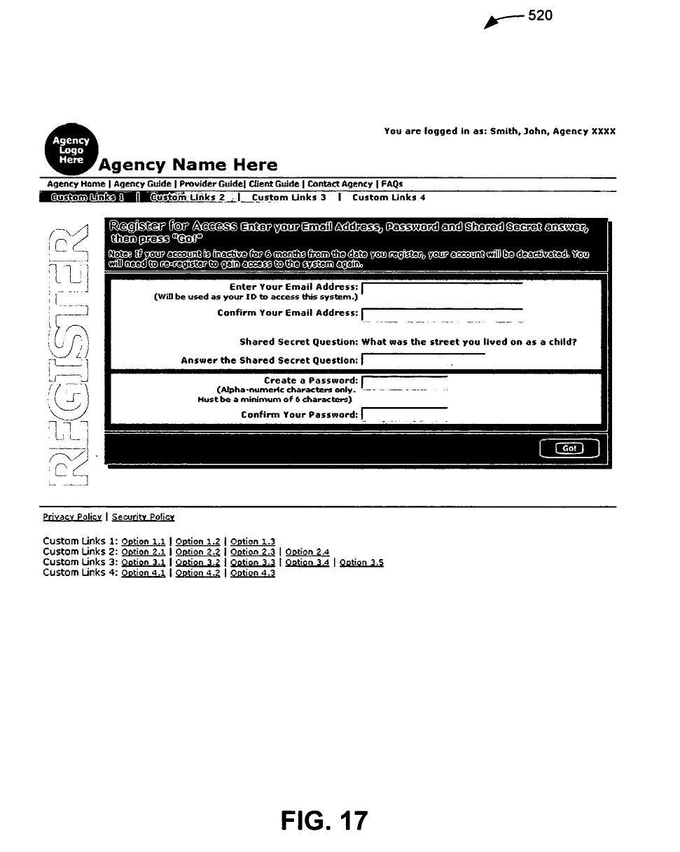

FIG. 17 illustrates one embodiment of a register for access web page 520. Register for access web page 520 allows a user of system 10 (shown in FIG. 1) to enter information about themselves in order to gain access to system 10 for the providing and administration of services as above described. In one embodiment, register for access web page 520 constitutes a second portion of a registration process and illustrates one possible user interface for online registration page 106 (shown in FIG. 3). Register for access web page 520 prompts a user to enter and confirm both their email address and a password, and to enter an answer to a secret question.

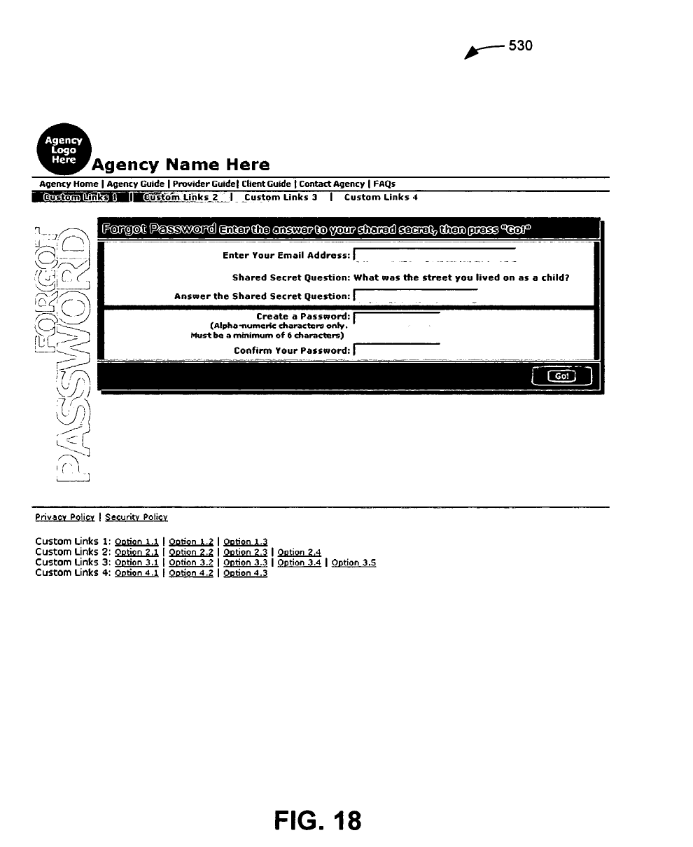

FIG. 18 illustrates one embodiment of a forgot password web page 530. Forgot password web page 530 allows a registered user of system 10 (shown in FIG. 1) who has forgotten or lost their password to gain access to system 10 through the correct answering of a question. Forgot password web page 530 illustrates one possible user interface for forgot password page 108 (shown in FIG. 3). Forgot password web page 530 prompts a user to enter both their email address and an answer to a secret question, and to create and confirm a new password.

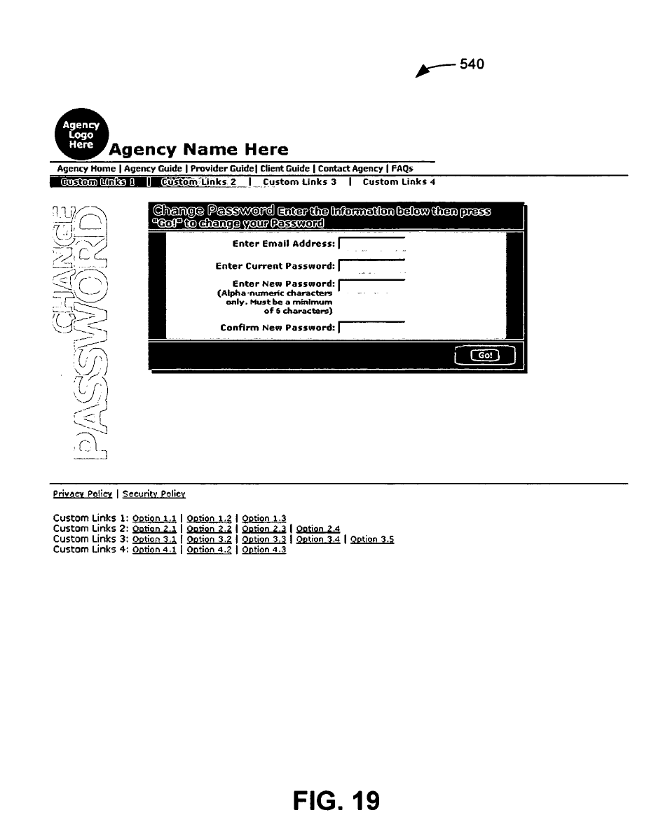

FIG. 19 illustrates one embodiment of a change password web page 540. Change password web page 540 allows a user of system 10 (shown in FIG. 1) to change their password which provides access to the capabilities of system 10. A user may need to change their password due to regular changes required by a system administrator, or simply because the user feels their current password has been compromised. Change password web page 540 illustrates one possible user interface for change password page 110 (shown in FIG. 3). Change password web page 540 prompts a user to enter both their email address and current password. Change password web page 540 further prompts the user to both enter and confirm their prospective new password.

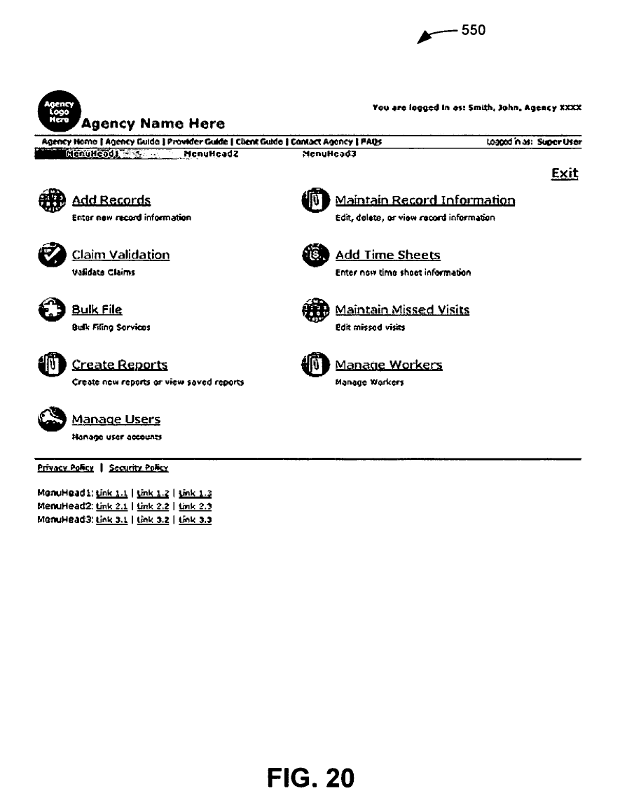

FIG. 20 illustrates one embodiment of a main menu web page 550. Main menu web page 550 provides a user with a user interface for the selecting of functions to be performed by system 10. In the embodiment illustrated, a user may select one or more of add records, maintain record information, claim validation, add time sheets, bulk file, maintain missed visits (e.g., edit/add missed visits), create reports (e.g. filter and sort reports), manage workers, and manage users. Main menu web page 550 illustrates one possible user interface for main menu page 104 (shown in FIG. 3).

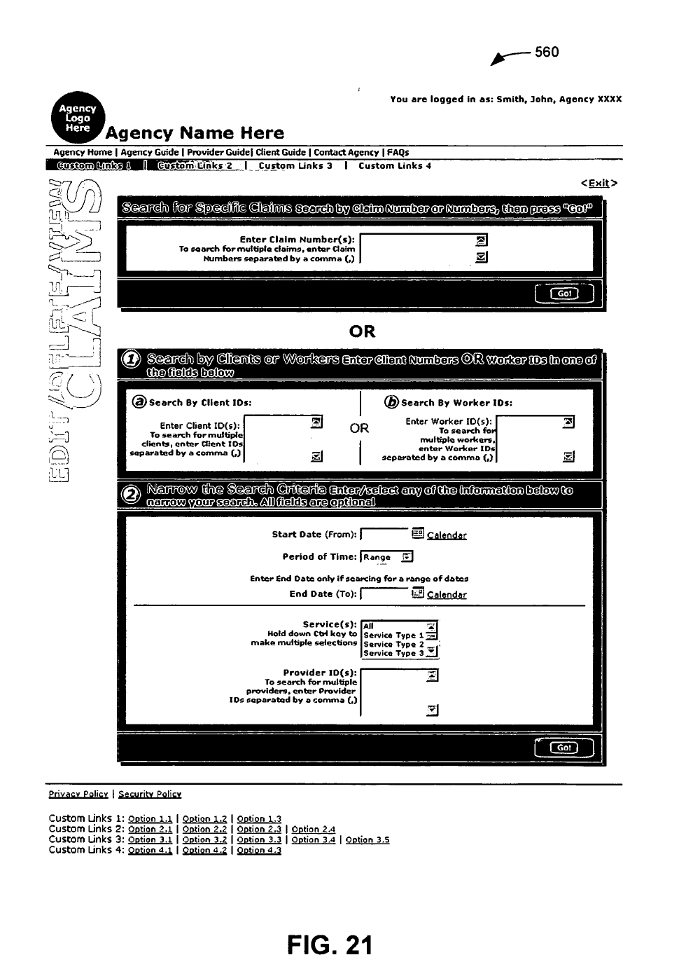

FIG. 21 illustrates one embodiment of a maintain claim information web page 560. Maintain claim information web page 560 provides a user with a user interface for searching for specific claims or searching by one or more of client identifiers and care givers (worker identifiers). In the embodiment illustrated, a user can enter one or more claim numbers to be searched for, one or more client identifiers to be searched, and one or more worker identifiers to be searched. In the embodiment illustrated, search criteria can be narrowed by entering one or more of a starting date, a period of time, an end date, one or more service types, and one or more provider identification numbers. Maintain claim information web page 560 is one embodiment of a user interface for search engine utilized for maintaining claim information through maintain claim information page 126 (shown in FIG. 3).

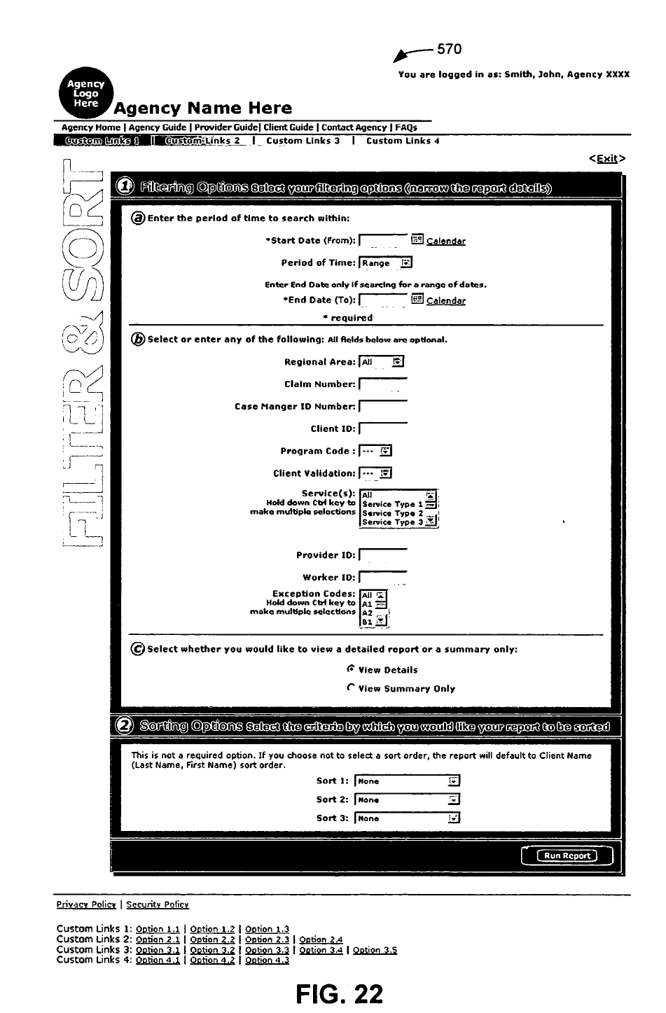

FIG. 22 illustrates one embodiment of a filtering and sorting web page 570. Filtering and sorting web page 570 provides a user with a user interface for filtering and sorting for reports that are generated by system 10. Specifically, one filtering option provided includes a starting date, a period of time, and an end date. Other criteria for filtering, in the embodiment illustrated, include a regional area, a claim number, a case manager identification number, a client number, selection of services, a provider identification number, a worker identification number and one or exception codes. Sorting options included in the embodiment illustrated, are selected from a plurality of pull down, selectable options. Filtering and sorting web page 570 is one possible user interface for a filtering and sorting page 156 (shown in FIG. 4).

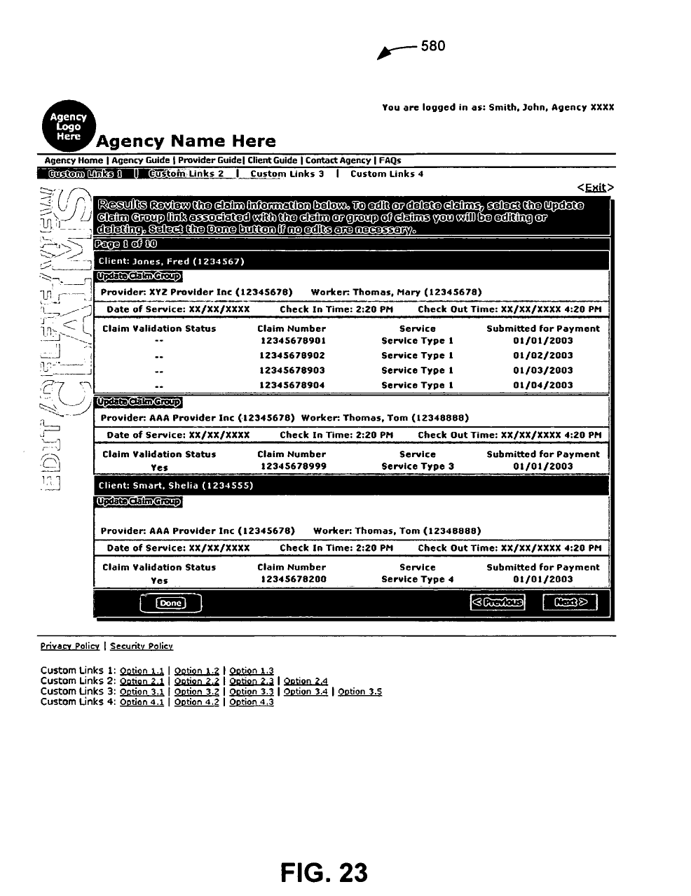

FIG. 23 illustrates one embodiment of an edit, delete, view claims web page 580. Edit, delete, view claims web page 580 provides a user with a user interface for editing, deleting, and viewing claims that have been submitted to system 10. Referring to the embodiment illustrated, web page 580 includes update claim group selection boxes for selecting individual claims of a client for editing or deletion. Edit, delete, view claims web page 580 is one embodiment of a user interface for providing an edit/delete/view claim results page 144 (shown in FIG. 3).

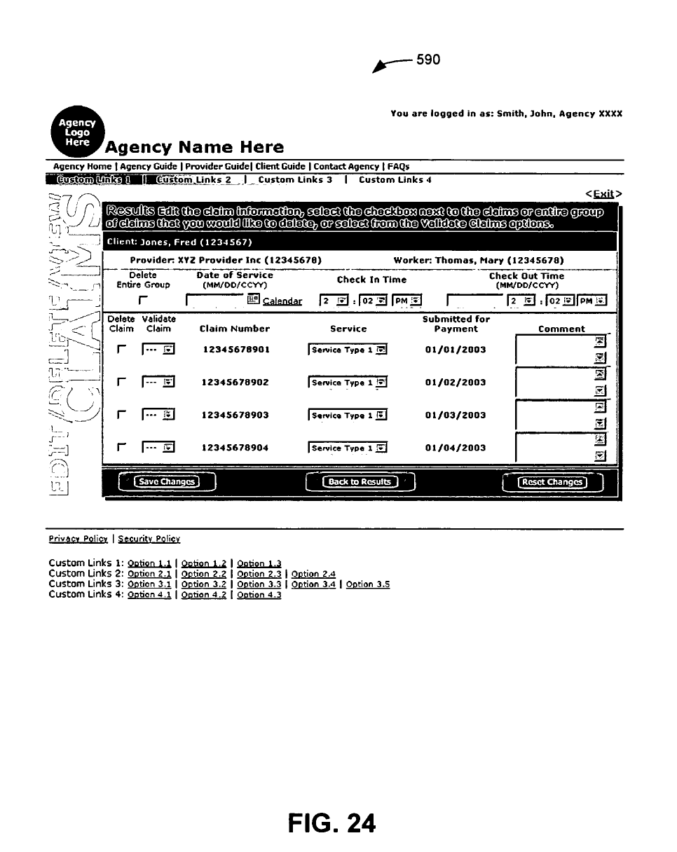

FIG. 24 illustrates another embodiment of an edit, delete, view claims web page 590. Edit, delete, view claims web page 590 provides a user with a user interface for editing individual claims that have been submitted to system 10 and selected for edit via edit, delete, view claims web page 580 (shown in FIG. 23). Referring to the embodiment illustrated, web page 590 includes selection boxes for selecting individual claims of a client for deletion or validation. The user may edit one or more of a date of service, a check in time, a check out time, and a service type for the claims of one or more providers. Edit, delete, view claims web page 590 is one embodiment of a user interface for providing an maintain claim information page 126 (shown in FIG. 3).

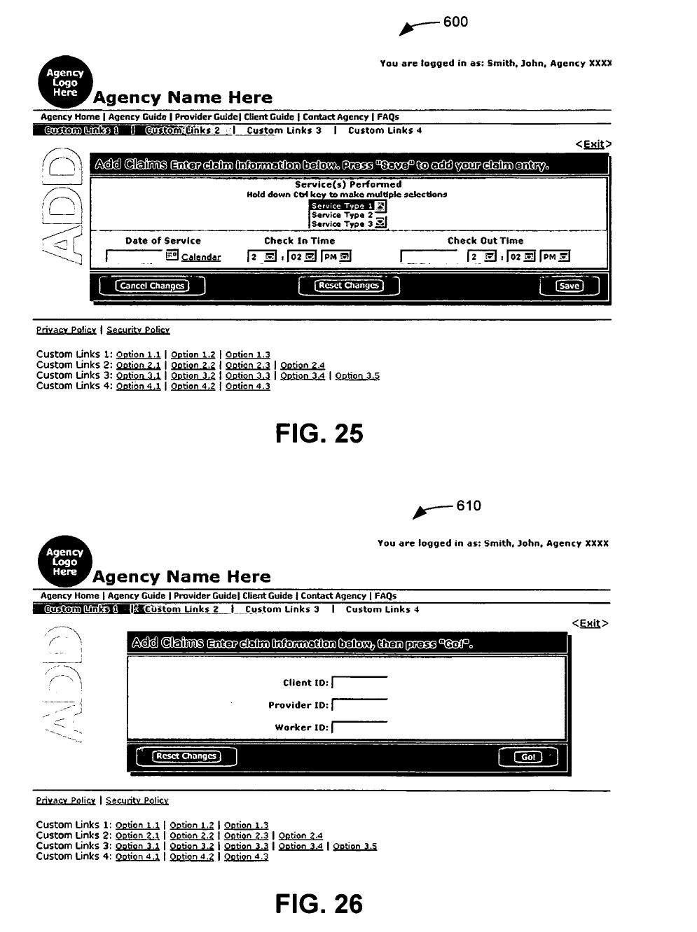

FIG. 25 illustrates one embodiment of an add claims web page 600. Add claims web page 600 provides a user with a user interface for adding claims for submission to system 10. Referring to the embodiment illustrated, web page 600 includes data entry boxes for entering one or more of a service performed, a date of service, a check in time, and a check out time to generate a new claim. Add claims web page 600 is one embodiment of a user interface for providing an add claim page 132 (shown in FIG. 3). FIG. 26 illustrates one embodiment of an add claims web page 610. Add claims web page 610 provides a user with a user interface for adding additional claim information for submission to system 10. Referring to the embodiment illustrated, web page 610 includes data entry boxes for entering one or more of a client identifier, a provider identifier, and a worker identifier. Add claims web page 600 is one embodiment of a user interface for providing an add claim page 130 (shown in FIG. 3).

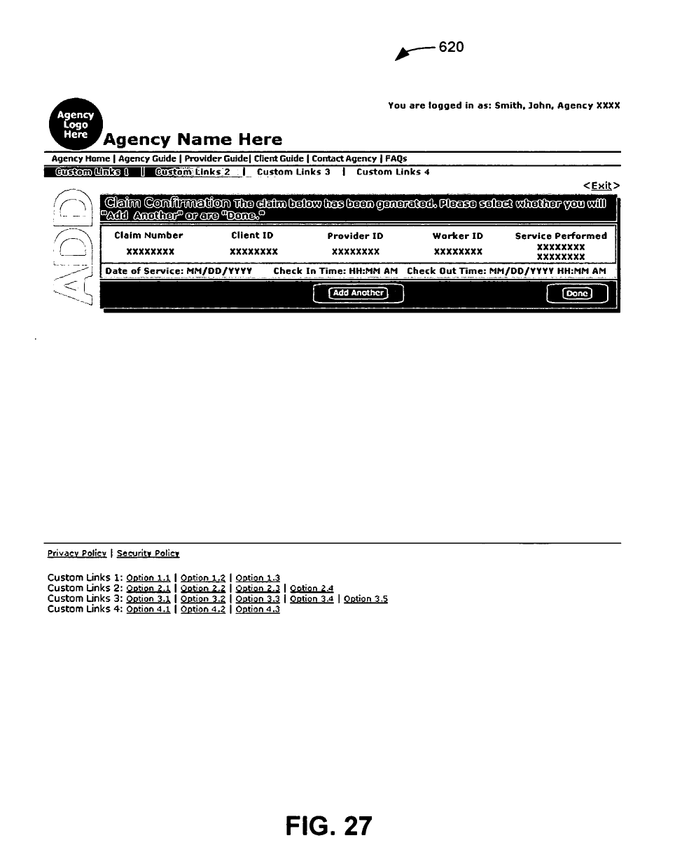

FIG. 27 illustrates one embodiment of a claim confirmation web page 620. Claim confirmation web page 620 provides a user with a user interface for confirming information regarding the claims submitted to system 10. Referring to the embodiment illustrated, web page 620 includes a claim number, a client identifier, a provider identifier, a worker identifier, the service performed, a date of service, a check in time, and a check out time for the claim. Claim confirmation web page 620 is one embodiment of a user interface for providing a confirmation page 148 (shown in FIG. 3).

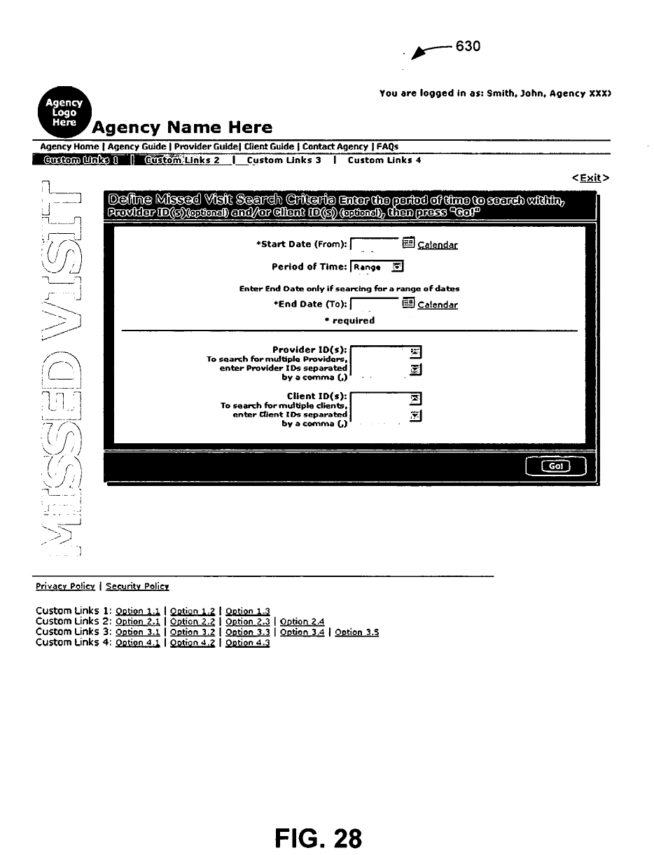

FIG. 28 illustrates one embodiment of a missed visit search criteria web page 630. Missed visit search criteria web page 630 provides a user with a user interface for entering search criteria regarding missed visits submitted to system 10. Referring to the embodiment illustrated, web page 630 includes capabilities for entering a start date, a period of time (e.g. a range, for example within the last month), an end date if searching for a range of missed visits, provider identifiers, and client identifiers. Missed visit search criteria web page 630 is one embodiment of a user interface for providing a missed visits search page 134 (shown in FIG. 3).

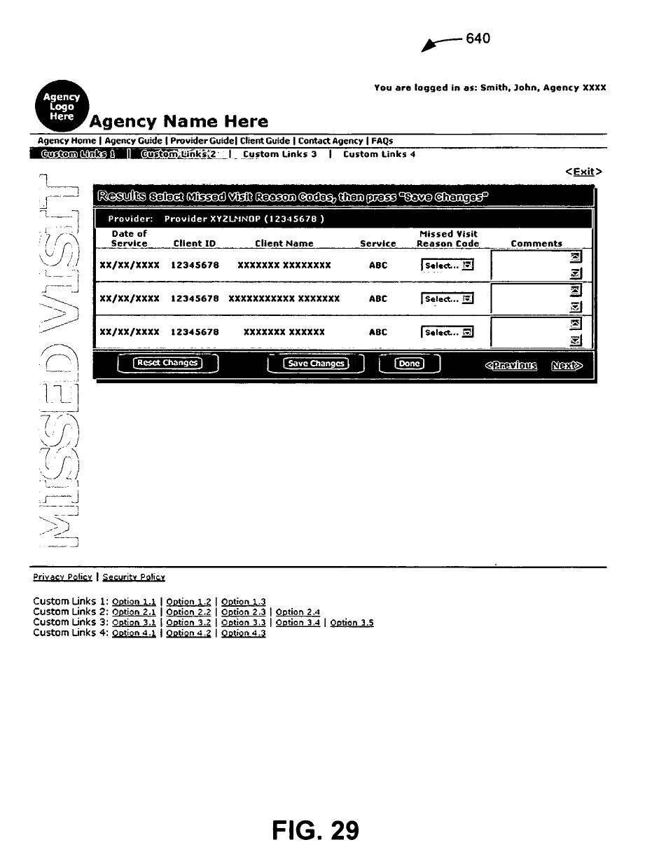

FIG. 29 illustrates one embodiment of a missed visit search results web page 640. Missed visit search results web page 640 provides a user with a user interface displaying information relating to missed visits submitted to system 10. Referring to the embodiment illustrated, web page 640 includes results for a provider identifier, and further includes a date of service, a client identifier, a client name, a service to have been performed, a selectable missed visit reason code, and a space for entry of comments. A user has a save changes option available. Missed visit search results web page 640 is one embodiment of a user interface for providing a missed visits search results page 136 (shown in FIG. 3).

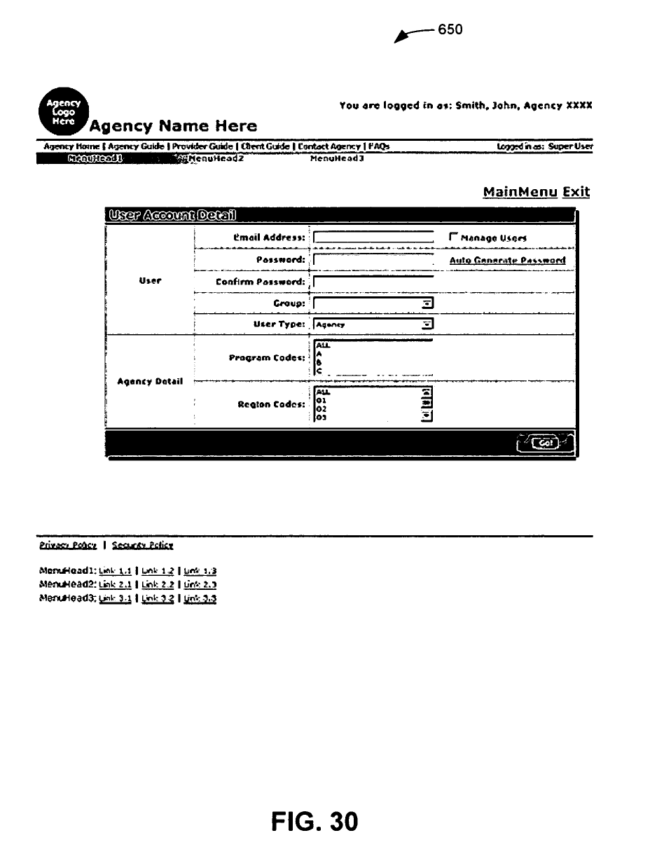

FIG. 30 illustrates one embodiment of a user administration web page 650. User administration web page 650 allows an administrative user of system 10 (shown in FIG. 1) to manage user account details within system 10. User administration web page 650 illustrates one possible user interface for add users page 184 (shown in FIG. 6). To create a user profile, user administration web page 650 allows an administrative user to enter and confirm both an email address and a password for the prospective user. Another embodiment (not shown) allows the administrative user to enter a secret question answer, to be utilized should the new user forget their password. User administration web page 650 also prompts the administrative user to select one or more user groups and types for the user (e.g., care giver, service provider, governmental agency) and further to enter agency details including a program code and a region code, if the new user is an agency user.

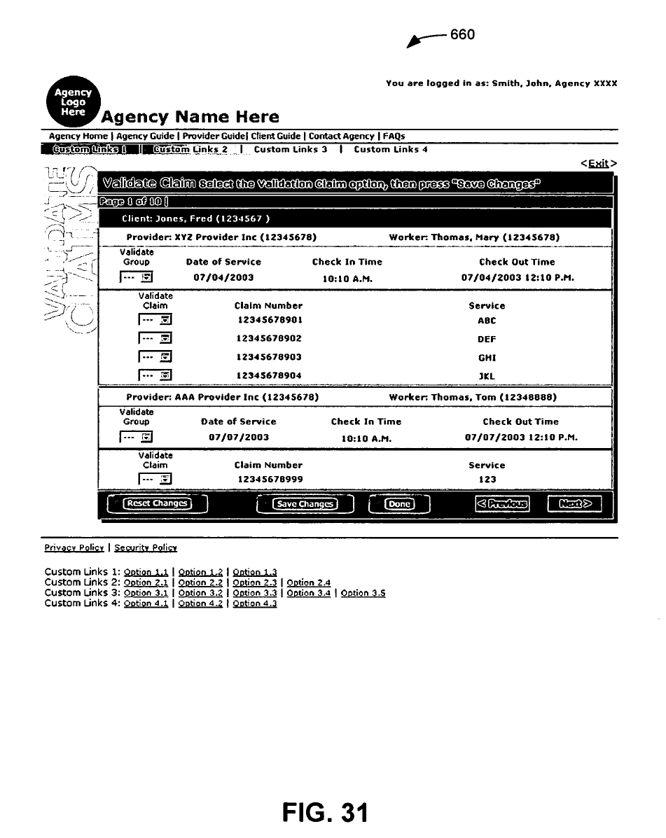

FIG. 31 illustrates one embodiment of a validate claims web page 660. Validate claims web page 660 provides a user with a user interface for validating claims that have been submitted to system 10 by various providers. Referring to the embodiment illustrated, web page 660 includes validate group selection boxes for selecting individual claim groups of a client for validation. Web page 660 also includes selection boxes for selecting individual claims of a group for validation. A claim number, a date of service, a check in time, a check out time, and a service type for the claims are also displayed. Validate claims web page 660 is one embodiment of a user interface for providing a client claim validation page 146 (shown in FIG. 3).

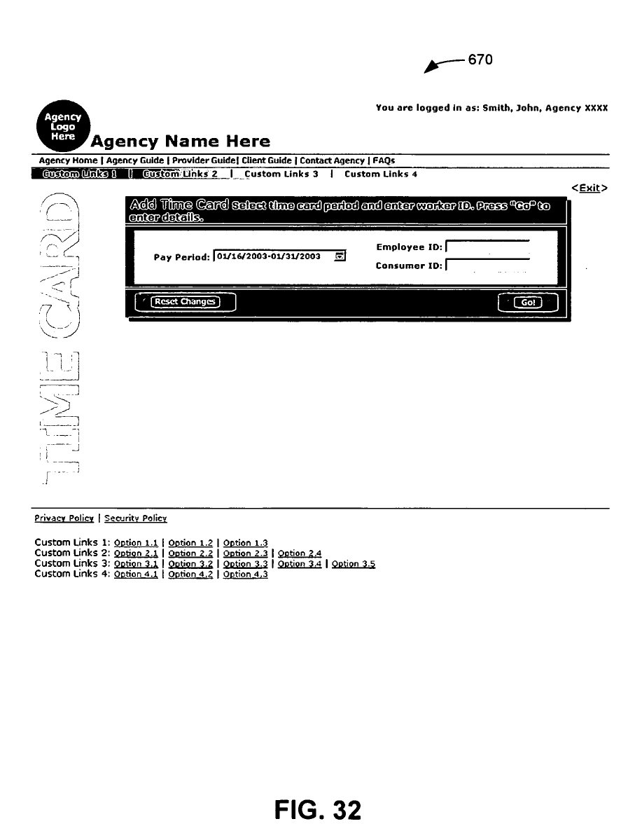

FIGS. 32-34 illustrate a time card function. The time card function allows a client to enter each visit made by a provider for each day within a pay period. For those installations where interactive voice response is not mandated across the state, utilization of the time card function is an option for submitting time electronically without completing a paper time sheet. The time card function further includes a validation process, but the user is allowed to enter each day and the specific service performed and the time of each visit and submit the group to system 10 all at one time. Time card data is entered on a per pay period basis in one embodiment.

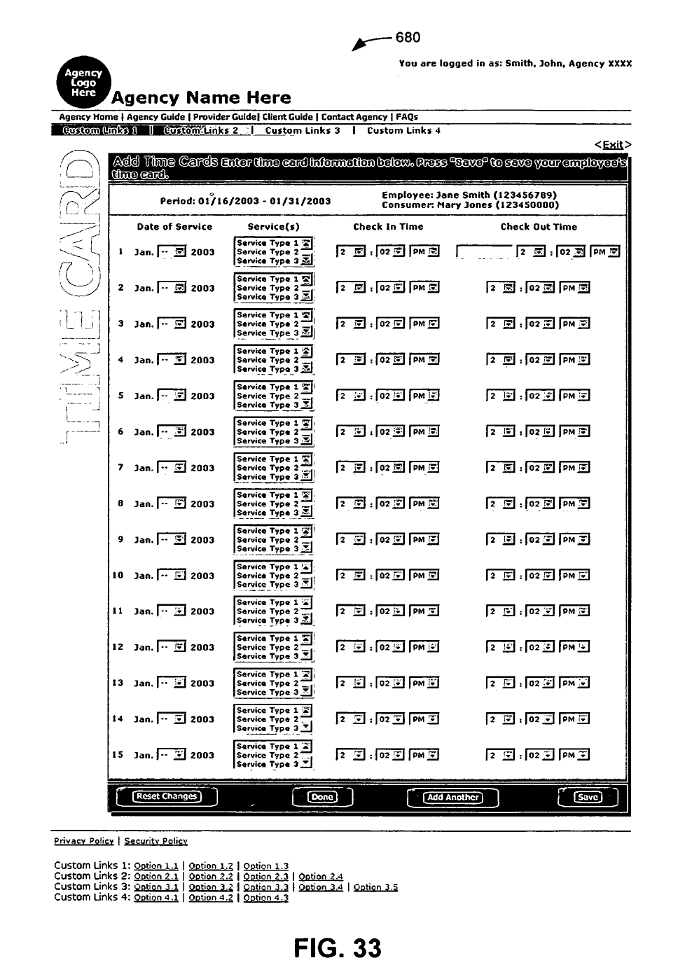

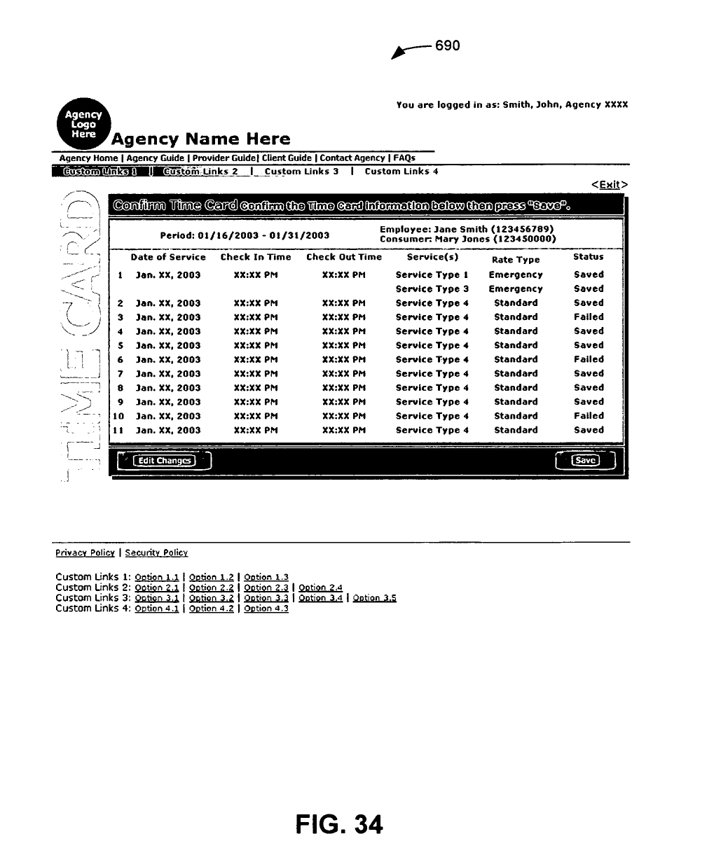

FIG. 32 illustrates one embodiment of add time card web page 670. Add time card web page 670 provides a user with a user interface for selecting a time card period and entering an employee identifier and consumer identifier. Add time card web page 670 is one embodiment of a user interface for providing a add time card selection page 138 (shown in FIG. 3). FIG. 33 illustrates one embodiment of an add time card information web page 680. Add time card information web page 680 provides a user with a user interface for entering dates of service, service types, check in time and check out times for a selected time card period and selected employee identifier and consumer identifier. Add time card information web page 680 is one embodiment of a user interface for providing a add time card details page 140 (shown in FIG. 3). FIG. 34 illustrates one embodiment of a time card confirmation web page 690. Time card confirmation web page 690 provides a user with a user interface for entering confirming previously entered dates of service, service types, check in time and check out times, rate types, and statuses for a selected time card period and selected employee identifier and consumer identifier. Time card confirmation web page 690 is one embodiment of a user interface for providing a confirmation page 148 (shown in FIG. 3) relating to time card entries.

The Bulk filing functionality described below allows provider agencies to enter claims for certain services where they may need to enter the actual number of units provided (home delivered meals) or answer yes/no to questions as to whether service was provided (adult day care, PERS Installation). In each of these services, the provider is given to option to enter claims for all authorized clients at one time instead of entering them individually for each client through the check-in/check-out process. The bulk filing option further allows a care giver to enter claims for both authorized and unauthorized services for groups of clients. For example, a care giver at an adult day care facility may have 15 clients per day. Some days, not all clients come to the care facility. For bulk filing, the care giver access system 10 and answers yes or no if each of the 15 clients were in the facility for a particular date of service.

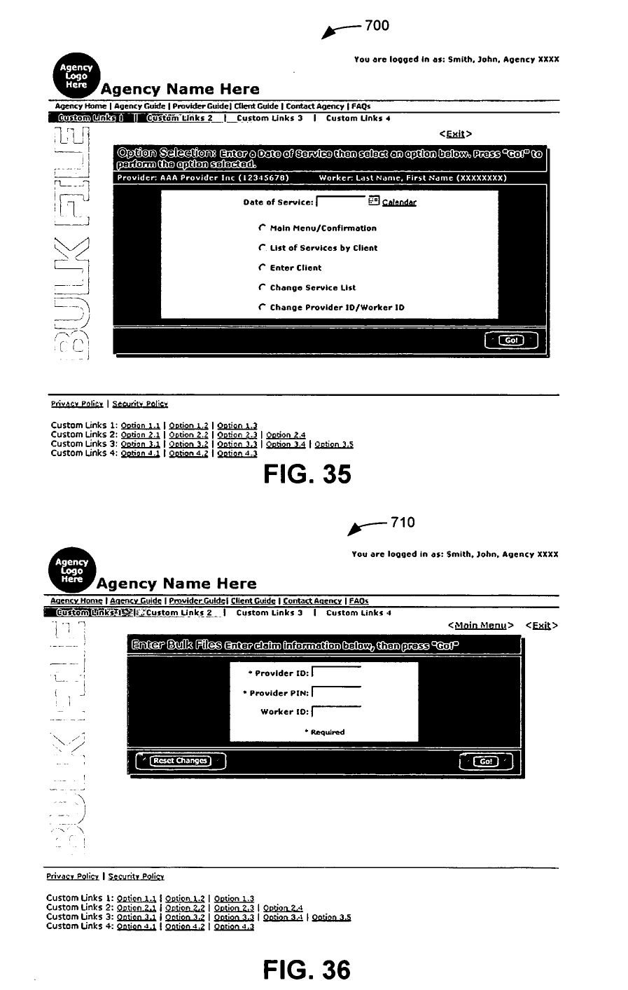

The web pages illustrated in FIGS. 35-40 provide details on how a user enters data for the bulk filing of claims. FIG. 35 illustrates one embodiment of a bulk filing option selection web page 700. Bulk filing option selection web page 700 provides a user with a user interface for entering a date of service and selecting a bulk file main menu, a listing of services by client, entering a client, changing a service list and changing provider and/or worker identifiers. Bulk filing option selection web page 700 is one embodiment of a user interface for providing a bulk filing option selection page 166 (shown in FIG. 5).

FIG. 36 illustrates one embodiment of a bulk filing search entry web page 710. Bulk filing search entry web page 710 provides a user with a user interface for searching bulk entries by entering one or more of a provider identifier, a provider PIN and a worker identifier. Bulk filing search entry web page 710 is one embodiment of a user interface for providing a bulk filing search entry page 162 (shown in FIG. 5).

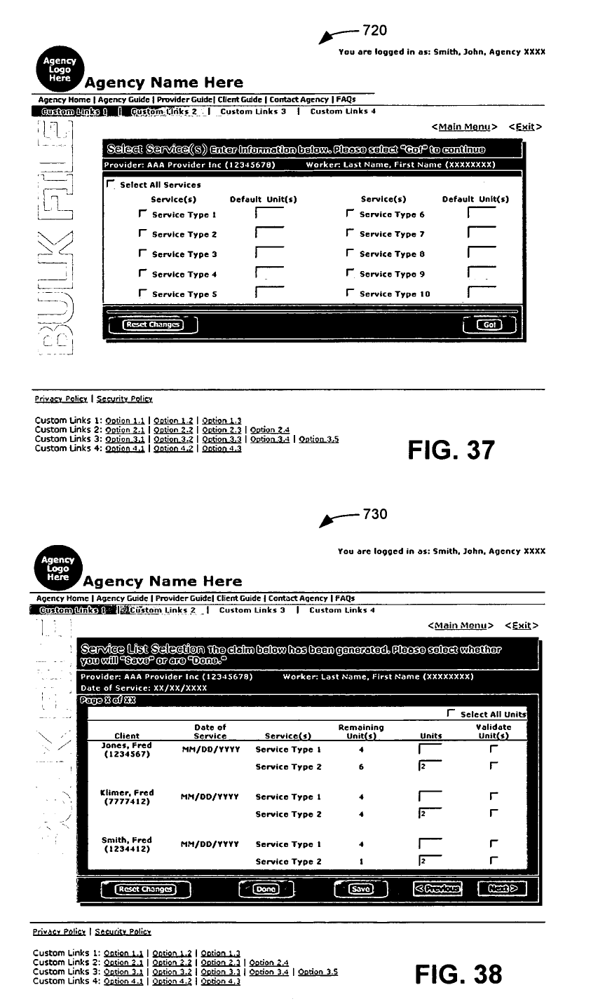

FIG. 37 illustrates one embodiment of a bulk filing select service web page 720. Bulk filing select service web page 720 provides a user with a user interface for selecting service types and units of those service types for bulk filing. For example, for the adult day care example described above, different amounts (units) may be delivered to different clients. With respect to the web pages described below, system 10 allows the provider to enter the same number of units for each client or to go through each client and enter the specific number of meals (units) delivered. Bulk filing select service web page 720 is one embodiment of a user interface for providing a bulk filing select service page 164 (shown in FIG. 5).

FIG. 38 illustrates one embodiment of a bulk filing service list selection web page 730. Bulk filing service list selection web page 730 provides a user with a user interface for verifying a remaining number of units of service for selected service types for clients. Bulk filing service list selection web page 730 is one embodiment of a user interface for providing a bulk filing service list selection page 168 (shown in FIG. 5).

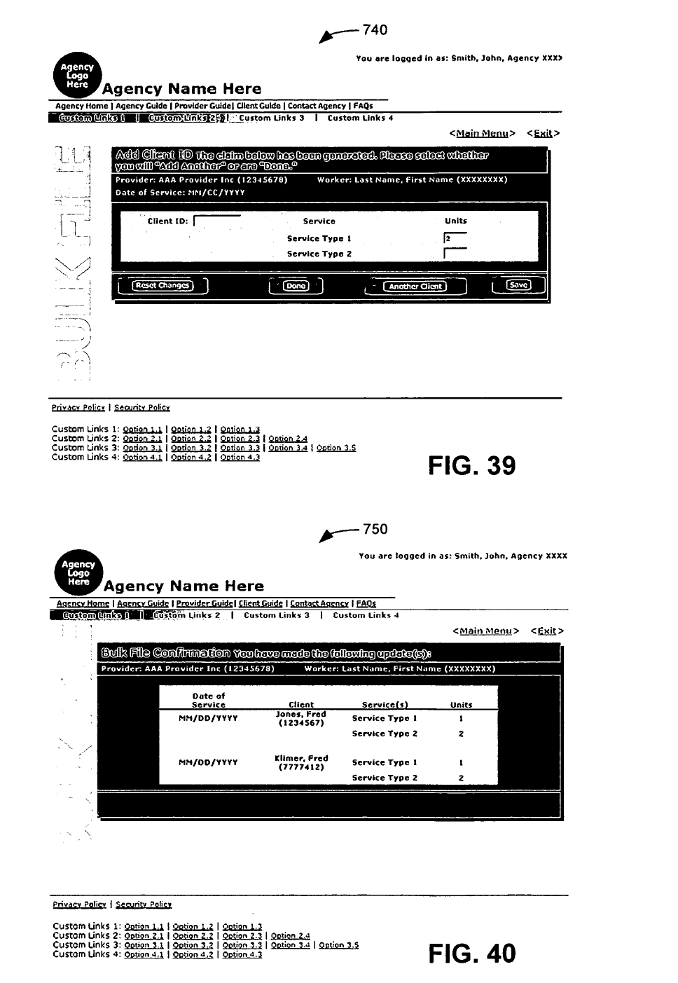

FIG. 39 illustrates one embodiment of a bulk filing add client web page 740. Bulk filing add client web page 740 provides a user with a user interface for adding a client to the bulk filing operation. Specifically, bulk filing add client web page 740 allows a user to enter a client identifier, and a number of units of each service type for the entered client identifier. Bulk filing add client web page 740 is one embodiment of a user interface for providing a bulk filing add client page 170 (shown in FIG. 5).

FIG. 40 illustrates one embodiment of a bulk filing confirmation web page 750. Bulk filing confirmation web page 750 provides a user with a user interface for verifying updates entered for the bulk filing operation. Specifically, bulk filing confirmation web page 750 provides a user with a date of service, a client (and client identifier), the service types for the client and the number of units for each service type. Bulk filing confirmation web page 750 is one embodiment of a user interface for providing a bulk filing confirmation page 172 (shown in FIG. 5).

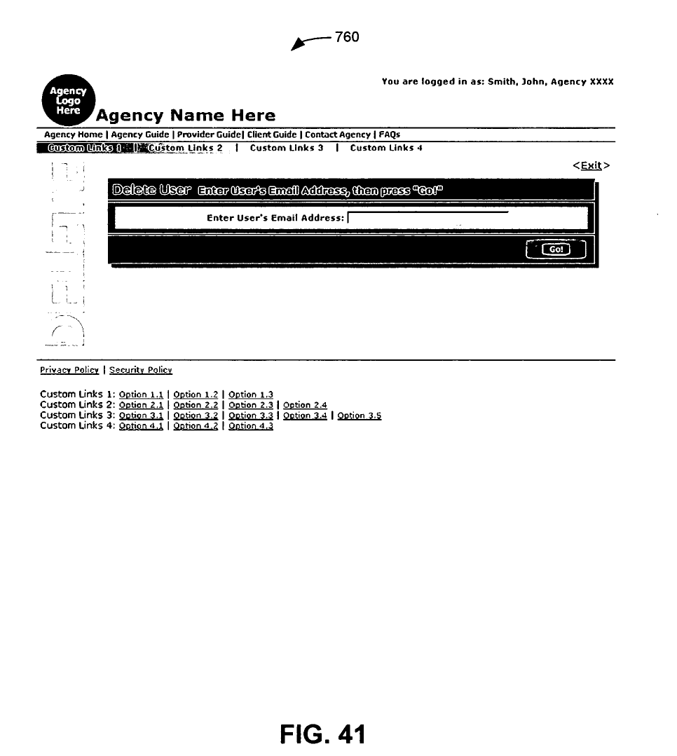

FIG. 41 illustrates one embodiment of a delete user web page 760. Delete user web page 760 provides an administrative user with a user interface for deleting registered users of system 10. Specifically, a user Email address for the user to be deleted is entered and submitted to system 10 by the administrative user. Delete user web page 760 is one possible user interface for a delete user page 186 (shown in FIG. 6).

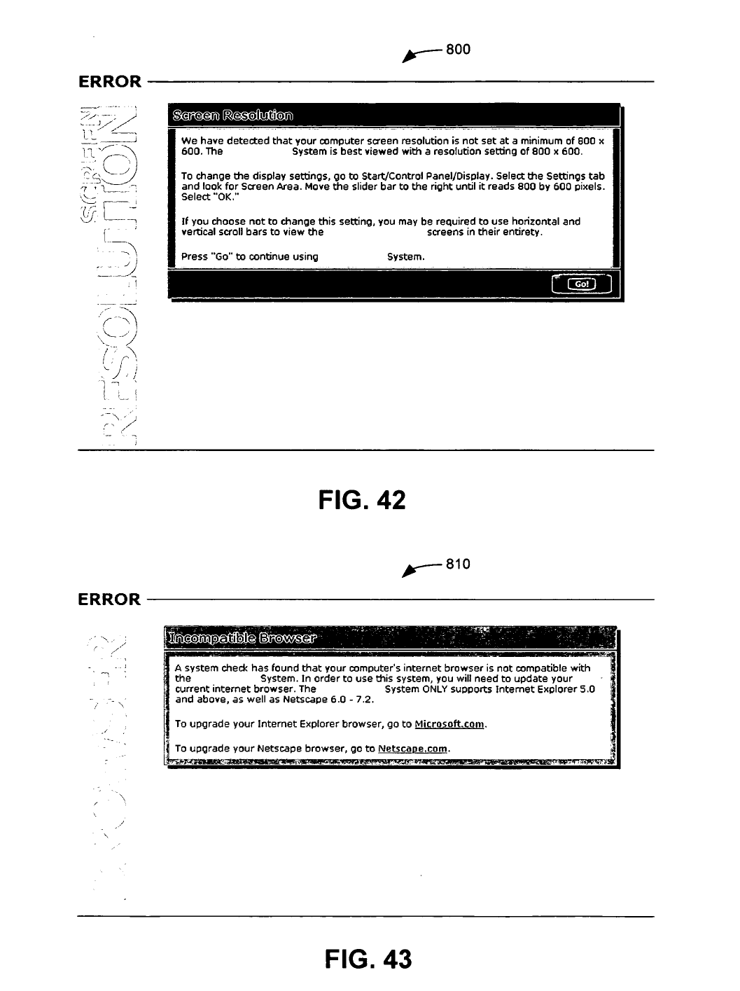

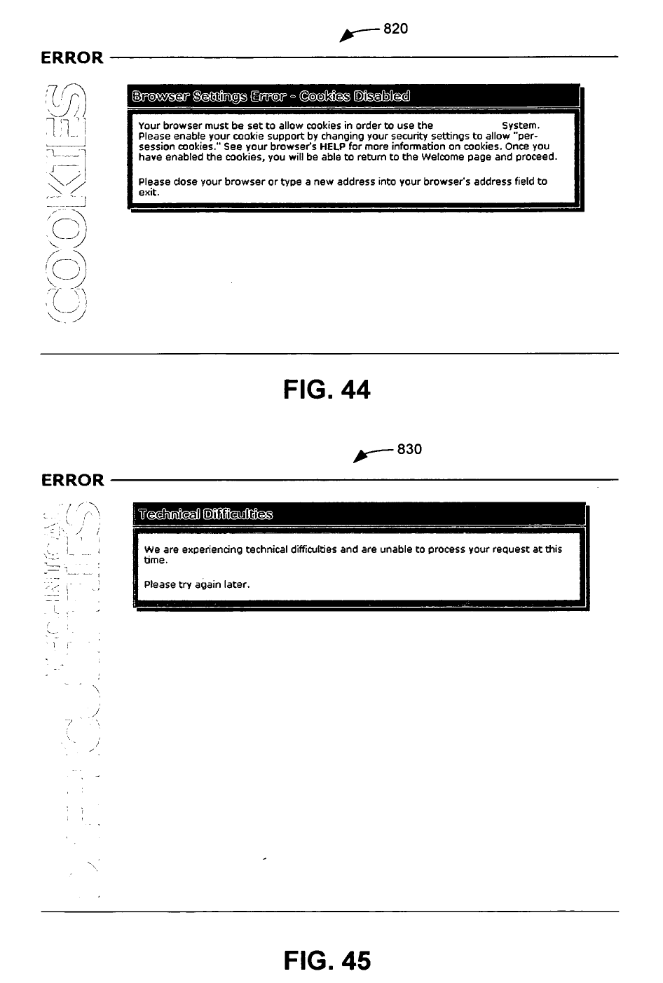

FIGS. 42-47 illustrate various system screen which are displayed by system 10 under various error conditions. Screen resolution error message 800 in FIG. 42 is one embodiment of a screen resolution page 191 (shown in FIG. 7) displayed when a user's computer screen is not set a correct resolution. Incompatible browser error message 810 in FIG. 43 is one embodiment of a incompatible browser page 192 (shown in FIG. 7) displayed when a user's web browser is not compatible with system 10. Browser settings error message 820 in FIG. 44 is one embodiment of a cookies check page 193 (shown in FIG. 7) displayed when a user's web browser settings are not compatible with system 10.

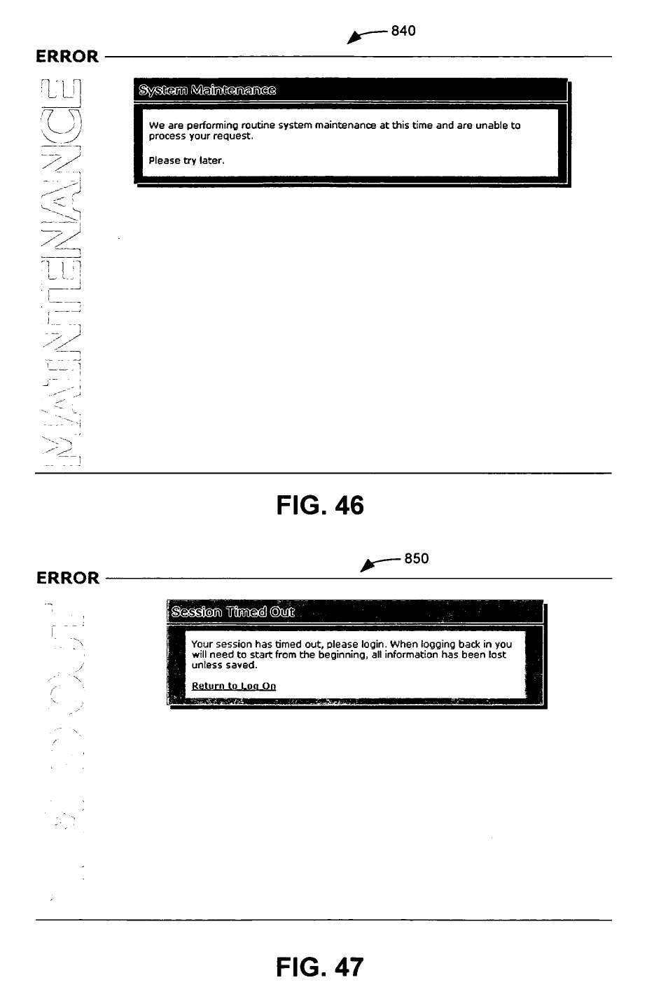

Technical difficulties error message 830 in FIG. 45 is one embodiment of a technical difficulties page 194 (shown in FIG. 7) displayed when system 10 is experiencing technical problems. System maintenance error message 840 in FIG. 46 is one embodiment of a maintenance page 195 (shown in FIG. 7) displayed when system 10 is undergoing maintenance. Session time out error message 850 in FIG. 47 is one embodiment of a page displayed when a user has not made an entry into one of the above described user interfaces within a specified time period.

As illustrated through the flowcharts and web pages described above, reports can be run on a case manager, service provider, individual care giver and recipient based on a variety of criteria. Agencies, for example, governmental agencies, can access these reporting statistics via a secure Internet site providing access to system 10, offering access to provider activity, care giver activity, client activity, and meaningful exception reporting statistics, such as missed visits, unauthorized visits, or incorrect services. The reports run from the Web offer data that is specific to queries by a user. Reports based on system performance are also available through imports or via files sent to the agency. The data can also be exchanged with the agency systems through batch uploads. Therefore, data can be accessible and analyzed from a variety of interface points.

From the various web pages described above, numerous reports can be generated based on input parameters. System 10 provides these reports for in-depth analysis of service levels. The reports are readily accessible via the Web and add a level of program administration that results in successful and reliable at-home care.

Types of reports that can be generated from the program data include: client activity, case management, exception reporting, service on non-authorized day, missed visit, service for terminated client, incorrect time of day, no check in or check out, hours greater than hours authorized, hours less than hours authorized, weekly hours less than hours authorized, phone number does not match, check out number does not match, check in number does not match, incorrect service provided, no authorization for provider, and worker ID unknown.

While described above in terms of an at-home and community based care program, the systems and methods described herein are contemplated to be applicable to other, similarly managed private and public sector programs and other encounter-based programs. Specific alternate program application examples include personal care services, environmental equipment, pest control, home modifications, child care, child protective services, consumer directed care, adult protective services, adult day care, home preparation/delivery of meals, personal emergency response system (PERS) installation, respite care, attendant care, transportation, nutritional supplements, appliances, personal assistant services, food and clothing, personal hygiene, health care, and rehabilitation services. In the cases of child care, child protective services, consumer directed care, adult day care, and adult protective services, the system can be utilized in connection with a case worker, a family member or friend of the recipient (care giver), or a care giving employee of a service provider who visits a home or other remote location (e.g., a school). In addition, for certain services such as meals, care givers and service providers are not required to enter data individually for each recipient, as multiple recipients may be receiving meals at a single location for a client (e.g., schools, retirement homes, nursing homes). In such an embodiment, the provider may simply enter the number of meals provided for an authorized client. Through web access the provider is able to enter claims for multiple clients at a single time for such services. The described systems and methods track and report on these visits and the providing of such care and services.

As for rehabilitation services, such services are typically provided to clients in locations other than a provider facility or institution, and such services are tracked, billed, and reported on. Specific examples include physical therapy, speech therapy, occupational therapy, or other direct client services. Further, systems and methods as herein described apply to any check in, check out program where remote workers, care givers, investigators, or another party need to travel into the field to meet with clients, recipients, or other third parties. The systems and methods described herein facilitate any type of check in, check out program, where there is a need or desire to track the location and time of the visit/meeting and prepare reports documenting these activities.

With respect to consumer directed care programs, the recipient of the services and his/her family actively participate in defining the recipient's needs through a comprehensive assessment. This assessment information serves as the foundation for the development of a plan of care, which identifies the formal and informal supports needed to support the recipient in the community. The case manager, facilitates the planning process, focusing on the individual recipient's identified priority needs by developing a plan which serves as the blueprint of how periodically budgeted funds will be spent to meet the needs identified in the plan of care. Since the plan of care is based on the needs of the individual, the plan varies from one individual to another.

The intended use of the funds is to purchase items or services identified in the recipient's plan of care, examples of which are listed above. Funds are made available to and managed by the recipient at the beginning of the budget period. Funds may be used to enable the individual to increase his/her abilities to perform activities of daily living. Inclusion in the plan and prior authorization from the case manager is required for such purchases. Decisions are based on the cost effectiveness of the purchase versus the cost of providing personal assistance services, as well as ensuring that the recipient's health and safety is not jeopardized because of such purchases. With respect to system 10 described herein, verifying an eligibility for services includes verifying that the recipient has funds available to pay for the requested services.

While the invention has been described in terms of various specific embodiments, those skilled in the art will recognize that the invention can be practiced with modification within the spirit and scope of the claims.

1. A method of managing services provided by providers to recipients, the method involving the use of an interactive system, said method comprising:
receiving, at the interactive system, a check in request from a provider;
operating the interactive system to verify an eligibility of the recipient for services;
providing to the provider, from the interactive system, a summary of services to be provided to the recipient; and
receiving, at the interactive system, a check out request from the provider.

2. A method according to claim 1 further comprising processing the check in request utilizing at least one of automatic number identification, a global positioning satellite system or other location based service to verify the provider is at the location of the recipient.

3. A method according to claim 1 further comprising utilizing the interactive system to track a length of time between check in and check out.

4. A method according to claim 1 further comprising:
generating at least one of bills and insurance claims for the provided services; and
electronically submitting the bills and insurance claims to at least one third party payer with the interactive system.

5. A method according to claim 4 wherein electronically submitting the bills and insurance claims comprises:
entering one or more of a provider identifier, a personal identification number, and a client identifier;
identifying the services being provided to the client;
determining the number of units for each service remaining for the client; and
generating a provider payment list.

6. A method according to claim 4 wherein electronically submitting the bills and insurance claims comprises bulk filing bills and insurance claims.

7. A method according to claim 6 further comprising:
entering a date of service;
identifying the provider service provided to each client;
determining a number of units for each of the services provided;
determining if the provider has authorized clients; and
entering the client identifiers and the number of units of a service for the clients that received services.

8. A method according to claim 7 further comprising operating the interactive system to provide a confirmation of the submitted bulk filed services.

9. A method according to claim 1 wherein receiving the check in request comprises receiving a telephone call at the interactive system from a telephone number of the recipient.

10. A method according to claim 1 further comprising providing one or more of reporting and analysis, agency access to provider activity, client activity, and exception reporting statistics with the interactive system.

11. A method according to claim 1 further comprising managing service providers, care givers, schedules, claims, and retrieving of data relating to the provided services utilizing data and analysis tools and interfaces with the interactive system.

12. A method according to claim 1 wherein the interactive system includes one or more of an interactive voice response system, personal digital assistants, global positioning satellite systems, tablet computers, laptop computers, and bar coded devices.

13. A method according to claim 1 wherein the interactive system provides support for one or more of database lookups, automatic number identification, a dialed number identification service, a global positioning satellite system, voice recognition, text-to-speech, terminal devices for the deaf, fax back, fax-on-demand, and voice messaging.

14. A method according to claim 1 further comprising providing reports relating to one or more of client activity, case management, exception reporting, service on non-authorized day, missed visit, service for terminated client, incorrect time of day, no check in or check out, hours greater than hours authorized, hours less than hours authorized, weekly hours less than hours authorized, phone number does not match, check out number does not match, check in number does not match, incorrect service provided, no authorization for provider, and worker ID unknown with the interactive system.

15. A method according to claim 1 further comprising importing and exporting data from and to a state agency with the interactive system.

16. A method according to claim 1 wherein the provided services include one or more of personal care services, environmental equipment, pest control, home modifications, child care, child protective services, consumer directed care, adult protective services, adult day care, home preparation/delivery of meals, personal emergency response system (PERS) installation, respite care, attendant care, transportation, nutritional supplements, appliances, personal assistant services, food and clothing, personal hygiene, health care, and rehabilitation services.

17. A method according to claim 1 wherein processing the check in request comprises at least one of identifying the provider, identifying a location of the provider and identifying the recipient.

18. A method according to claim 1 wherein identifying the provider comprises receiving a worker identification number and identifying the recipient comprises receiving a client identification number.

19. A method according to claim 1 further comprising:
receiving from the provider, at the interactive system, additional services to be provided to the recipient; and
providing to the provider an eligibility of the recipient for the additional services.

20. A method according to claim 1 further comprising:
verifying whether a check-in record exits within the interactive system;
generating a check-out summary if the check-in record exists; and
entering at least one of a worker identifier and a provider selection, identifying a client by one of automatic number identification and entered client identifier, identifying the services provided, and generating a check-out summary if the check-in record did not exist.

21. A method according to claim 4 wherein generating at least one of bills and insurance claims for the provided services further comprises generating Medicaid claims in a HIPAA compliant electronic data interchange transaction.

22. A method according to claim 1 wherein for consumer directed care, said method comprising preparing the summary of services to be provided to the recipient from a plan of care for the recipient.

23. A computer-based system for managing transactions associated with remote site care services, comprising:
an interactive system;
a web server; and
a database server comprising a database, said system configured for access by providers through at least one of said web server and said interactive system, said computer-based system configured to receive check in requests from providers, verify an eligibility of recipients for services, provide a summary of services to be provided to the recipients, and receive check out requests from the providers.

24. A system according to claim 23 wherein said interactive system comprises one or more of automatic number identification, a global positioning satellite system, location based services, an interactive voice response system, personal digital assistants, tablet computers, laptop computers, and bar coded devices.

25. A system according to claim 23 wherein to verify provider check in, said system receives one or more of a provider identification, a client identification, and a service identification from a telephone of a service recipient.

26. A system according to claim 23 wherein to verify an eligibility of a recipient, said interactive system accesses said database to retrieve eligibility data for the recipient.

27. A system according to claim 23, said system configured to export data relating to provided services to a state agency system.

28. A system according to claim 23 configured with an administrative function accessible by a user, said administrative function allowing a user to edit, delete, and view claims, add claims, edit and delete missed service provider visits, and perform client claim validation.

29. A system according to claim 23 wherein to facilitate the providing of like services to multiple recipients, said system is configured to allow a provider to enter a number of such services provided during a single check in.

30. A system according to claim 29 wherein said system is configured to:
receive at least one of a provider identifier, a provider personal identification number, a worker identifier, and a plurality of client identifiers;
allow a provider to select a number of services to be provided for each client;
prompt a provider to enter a number of units for each service provided to each client; and
generate a confirmation file that includes service and unit information for each serviced client.

31. A system according to claim 23 configured with a time card function, said time card function allowing a user to track the service types provided to clients over specified periods.

32. A system according to claim 23 wherein said system is configured to administer one or more plans of care for one or more participants in a consumer directed care program.

33. A method for using an interactive voice response (IVR) system to manage services provided by a provider to one or more recipients at a recipient location, said method comprising:
accessing the IVR system to check in the provider;
retrieving the services to be provided to each recipient using the IVR system;
verifying an eligibility of each recipient to receive the retrieved services using the IVR system; and
accessing the IVR system to check out the provider once the eligible services have been rendered by the provider.

34. A method according to claim 33 further comprising:
selecting additional services to be provided to the recipient using the IVR system; and
verifying an eligibility of the recipient to receive the additional services using the IVR system.

35. A method according to claim 33 further comprising providing a check in summary to the provider using the IVR system.

36. A method according to claim 33 wherein verifying an eligibility of the recipient comprises identifying the recipient utilizing automatic number identification of the telephone accessing the IVR system.

37. A method according to claim 33 verifying an eligibility of the recipient comprises retrieving a plan of care for a consumer directed care recipient.

38. A method according to claim 33 wherein accessing the IVR system to check in the provider comprises one or more of:
entering a worker identification number;
selecting a service provider; and
entering a client identification number.

39. A method according to claim 33 wherein accessing the IVR system to check out the provider care giver comprises:
verifying a check in record exists using the IVR system; and
providing a check out summary to the provider, based on the check in summary, using the IVR system.

40. A method according to claim 33 wherein accessing the IVR system to check out the provider comprises:
determining a check in record does not exist using the IVR system;
entering a worker identification number;
selecting a service provider;
identifying the recipient; and
providing a check out without check in summary to the care giver.

41. A method according to claim 33 wherein identifying the recipient comprises one or more of attempting to identify the recipient using automatic number identification and entering a client identification number.

42. A method according to claim 33 further comprising providing payments to the provider.

43. A method according to claim 42 wherein providing payments to the provider comprises:
entering a provider identification number and a valid PIN;
determining if payments are to be made; and
providing a payment list.

44. A method according to claim 33 further comprising causing the IVR system to generate a file summarizing all services and units of services provided to clients.

45. An interactive voice response (IVR) system to manage services provided by a provider to one or more recipients at a recipient location, said IVR system configured to:
receive a telephone call from a recipient location to check in the provider;
provide the provider with services to be provided to the recipient;
verify an eligibility of the recipient to receive the services; and
receive a telephone call from a recipient location to check out the provider.

46. An interactive voice response system according to claim 45 further configured to:
receive a selection of additional services to be provided to the recipient from the provider; and
verifying an eligibility of the recipient to receive the additional services.

47. An interactive voice response system according to claim 45 wherein the services provided are one of Medicare and Medicaid services.

48. An interactive voice response system according to claim 45 wherein said system is configured to verify an availability of funds for services provided within a consumer directed care plan of care.
